(19) United States
(12) Patent Application Publication
(10) Pub. No.: US 2022/0138641 A1
(43) Pub. Date: May 5, 2022

(54) DYNAMICALLY SELECTING GEOGRAPHIC REGIONS BASED ON THIRD PARTY SERVERS USING MACHINE LEARNING PROCESSES

(71) Applicant: Graham S. Lee, Vancouver (CA)

(72) Inventor: Graham S. Lee, Vancouver (CA)

(21) Appl. No.: 17/486,118

(22) Filed: Sep. 27, 2021

Related U.S. Application Data
(63) Continuation of application No. 16/906,823, filed on Jun. 19, 2020, now abandoned.

(51) Int. Cl. G06Q 10/02; G01C 21/34; G01C 21/00; G06N 20/00

(52) U.S. Cl. CPC G06Q 10/025; G01C 21/343; G06N 20/00; G01C 21/3885; G01C 21/3453

(57) ABSTRACT

A method may include designating, by a server, a designated geographic region and identifying a set of user accounts associated with mobile electronic devices located within the designated geographic region. The method may also include obtaining information from third party servers related to interactions of the user accounts with the third party servers. The method may also include receiving, from an advanced user account, a request for an automatically generated list of distinct geographic regions. The method may also include using a machine learning process to select geographic regions as the list of distinct geographic regions, the designated geographic region included in the list of distinct geographic regions based on the machine learning process acting on the information from third party servers and a quantity of user accounts. The method may also include transmitting the generated list to an electronic device associated with the advanced user account.

### BACKGROUND

Performers, such as bands, stand-up comedians, artists, and motivational speakers, sometimes desire to go on tour to connect with fans through live performances. When a performer desires to go on tour, determining in advance the financial viability of which venues to book on which dates can be very difficult. For example, when the owner of a venue, such as an indoor arena or an outdoor amphitheater, agrees to be a stop on a tour of a performer, the venue owner may book one or more dates based on the number of tickets that the performer estimates will be sold. Either the performer or the venue owner, or both, may lose money should the performer's estimate on ticket sales end up being too high. Especially where a performer is relatively new and does not yet have a track record of ticket sales at similar venues, the venue owner may be hesitant to agree to be a stop on a potential tour for fear of losing money should sufficient ticket sales not materialize. Therefore, many performers, especially up-and-coming performers, are prevented from going on tour due to the risk of not selling enough tickets at desired venues.

Another problem related to scheduling a tour relates to the middlemen who take a cut of the profits both from the venue owners (e.g., booking agents and promoters who have contracts to rent out venues) as well as the performers (e.g., managers who represent performers in booking tours). The costs associated with middlemen also sometimes prevent performers, especially up-and-coming performers, from going on tour.

The subject matter claimed herein is not limited to embodiments that solve any disadvantages or that operate only in environments such as those described above. Rather, this background is only provided to illustrate one example technology area where some embodiments described herein may be practiced.

### SUMMARY

In some embodiments, a computer-implemented method may be performed by a server including one or more processors. The method may include designating, by the server, a designated geographic region. The method may also include identifying a set of user accounts associated with mobile electronic devices located within the designated geographic region. The method may also include obtaining, by the server, information from a plurality of third party servers related to interactions of the user accounts with the plurality of third party servers. The method may also include receiving, at the server and from an advanced user account, a request for an automatically generated list of distinct geographic regions. The method may also include using a machine learning process to select a plurality of geographic regions as the list of distinct geographic regions, the designated geographic region included in the list of distinct geographic regions based on the machine learning process acting on the information from third party servers and a quantity of user accounts. The method may also include transmitting the generated list of distinct geographic regions to an electronic device associated with the advanced user account.

In some embodiments, the method may alternatively include, in response to determining that an insufficient number of ticket deposits are received for the potential tour by a predetermined cutoff date, automatically generating, using the machine learning classifier at the server, a projected number of tickets that will be purchased for each of the venues in a remaining ticket sales period and a projected performer revenue for each of the venues in the remaining tickets sales period. In these embodiments, the method may also include receiving, at the server, a revised virtual lineup of venues for the potential tour from the multiple virtual lineups of venues. In these embodiments, the method may also include, facilitating, by the server, a booking of each of the venues in the revised virtual lineup of venues for an actual tour, ticket sales for the actual tour, and distribution of revenue from the ticket sales to the performer.

In some embodiments, the venue information may be received via a smartphone app from the multiple venue owners, the tour preferences may be received via the smartphone app from the performer, and the ticket deposits for the potential tour and the tickets sales for the actual tour may be received via the smartphone app. In these embodiments, the fan information may be at least partially received via the smartphone app from fans. In these embodiments, the fan information may include performance attendance history and/or preferred performers of fans residing in the multiple venue markets. Additionally or alternatively, in these embodiments, the fan information may be at least partially received via the smartphone app from the venue owners. In these embodiments, the fan information may include past performance statistics from the venues of the venue owners, with the past performance statistics from the venues of the venue owners including one or more of a performer who performed the past performance, a genre of the past performance, or ticket sales of the past performance.

In some embodiments, the fan information may be at least partially received from media streaming platforms. In these embodiments, the fan information may include genres of media streamed on the media streaming platforms by fans residing in the multiple venue markets.

In some embodiments, the fan information may be at least partially received from social media platforms. In these embodiments, the fan information may include performers followed on the social media platforms by fans residing in the multiple venue markets.

In some embodiments, one or more non-transitory computer-readable media may include one or more computer-readable instructions that, when executed by one or more processors, cause the one or more processors to perform a method for automatic generation of a virtual lineup of venues for a potential tour of a performer.

In some embodiments, a server may include one or more processors and one or more non-transitory computer-readable media. The one or more non-transitory computer-readable media may include one or more computer-readable instructions that, when executed by the one or more processors, cause the one or more processors to perform a method for automatic generation of a virtual lineup of venues for a potential tour of a performer.

It is to be understood that both the foregoing summary and the following detailed description are explanatory and are not restrictive of the invention as claimed.

### BRIEF DESCRIPTION OF THE DRAWINGS

Embodiments will be described and explained with additional specificity and detail through the use of the accompanying drawings in which:

FIG. 1 illustrates an example system configured for facilitating tours using a touring app;

FIGS. 2A-2G are a flowchart of an example method for facilitating a tour using a touring app;

FIGS. 3-23 illustrate various screens of a touring app;

FIGS. 24A-24D are a flowchart of an example method for automatic generation of a virtual lineup of venues for a potential tour of a performer; and

FIG. 25 illustrates an example computer system that may be employed in facilitating a tour using a touring app.

### DETAILED DESCRIPTION

When performers desire to go on tour, determining in advance the financial viability of which venues to book on which dates can be very difficult. For example, venues may be booked based on the number of tickets that the performer estimates will be sold, but either the performer or the venue owner, or both, may lose money should the performer's estimate on ticket sales ends up being too high. Therefore, many performers, especially up-and-coming performers, are prevented from going on tour due to the risk of not selling enough tickets at desired venues. Further, the costs associated with middlemen (e.g., booking agents, promoters, managers, etc.) also sometimes prevent performers, especially up-and-coming performers, from going on tour.

Some embodiments disclosed herein may enable automatic generation of a virtual lineup of venues for a potential tour of a performer. For example, where a performer desires to go on tour, some embodiments may include a touring app that be employed on smartphones (e.g., a smartphone app) by the performer, by venue owners, and by fans to manage the tour from start to finish. The touring app may be associated with a server. For example, multiple venue owners associated with multiple venue markets may send venue information (e.g., total number of seats, seat counts in different configurations, venue logistics, venue costs, a venue bookings calendar, etc.) to the server via the touring app. Next, fan information (e.g., fan performance attendance history, preferred performers, past performance statistics at venues, genres of music listened to by fans, performers followed on the social media platforms by fans, etc.) may be gathered by the server or sent by fans to the server via the touring app. Then, a performer may send tour preferences (e.g., area of the world for the tour, venue size for the tour, ticket price for the tour, time frame for the tour, compensation preferences, etc.) to the server via the touring app. The server may then automatically generate, using a machine learning classifier at the server, multiple virtual lineups of venues for a potential tour of the performer based on the venue information, the tour preferences, and the fan information. The multiple virtual lineups of venues may include performance dates for each of the venues, a projected number of fans who will purchase tickets for each of the venues (or a projected number of tickets that will be purchased for each of the venues), and a projected performer revenue for each of the venues. These virtual lineups of venues for the potential tour may then be presented to the performer on the touring app, allowing the performer to use the projected ticket sales and projected performer revenue to select one of the virtual lineups of venues on the touring app and send the selected virtual lineup of venues to the server via the touring app. The server may then facilitate, via the touring app, the taking of ticket deposits (e.g., a deposit of $20 for a $100 ticket) for the potential tour from fans. Then, if after a predetermined cutoff date a sufficient number of ticket deposits are received for the potential tour (e.g., enough ticket deposits that will result in the performer and each venue making a profit on the tour), the server may facilitate, via the touring app, a booking of each of the venues in the selected virtual lineup of venues for an actual tour, ticket sales for the actual tour (e.g., payment of the remaining $80 of the $100 ticket), and distribution of revenue from the ticket sales to the performer and to the venue owners.

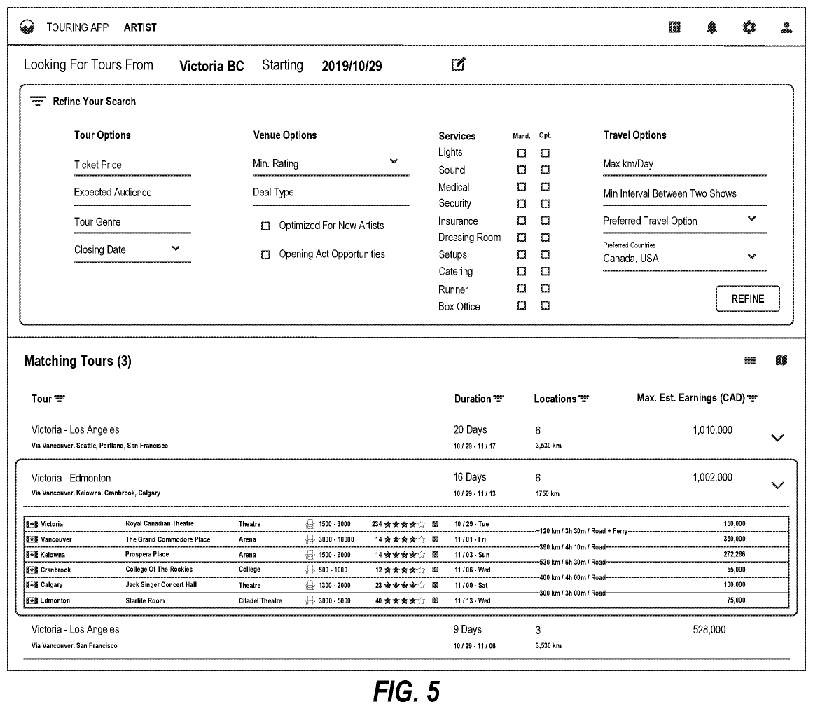

As used herein, the term “lineup of venues” may refer to a sequence of venues, and a show date or show dates for each of the venues, for a potential or actual tour of a performer. In the case of a “virtual lineup of venues for a potential tour,” the sequence of venues and/or the show date or show dates for each of the venues may change prior to the potential tour being booked as an actual tour, for example due to insufficient ticket deposits being received for one or more of the venues. For example, as disclosed in FIG. 5, a potential tour from Victoria to Edmonton lasting 16 days may include a virtual lineup of venues that includes a show in Victoria on October 20, a show in Vancouver on November 1, a show in Kelowna on November 3, a show in Cranbrook on November 6, a show in Calgary on November 9, and a show in Edmonton on November 14. However, should an insufficient number of ticket deposits be received for one of the six shows of this potential tour, such as the show in Calgary on November 9, that show may be cancelled from the lineup of venues of the tour, resulting in an actual tour with only five shows instead of six shows.

In this manner, some embodiments disclosed herein may employ a machine learning classifier to automatically and relatively accurately project a number of fans who will purchase tickets (or a number of tickets that will be sold), and a performer revenue for a performer, for each of the venues in a virtual lineup of venues for a potential tour of the performer. This relatively accurate projection of ticket sales and performer revenue on a venue-by-venue basis may enable a performer to select venues for the potential tour that are most likely to attract the most fans for the performer and/or to generate the most revenue for the performer. This relatively accurate projection may therefore allow a performer to determine in advance the financial viability of which venues to book on which dates. Further, this relatively accurate projection may also allow a performer to cut out the middlemen (e.g., booking agents, promoters, managers, etc.) to reduce the costs of a tour and increase the performer revenue and the venue revenue from the tour.

Further, in some embodiments, the touring app, and/or a website with functionality similar to the touring app, may allow performers, venue owners, and fans to interact directly, thereby streamlining the overall concert tour planning process for performers. Additionally, the touring app and/or the website may allow a performer to garner the support of their fans to both drive ticket sales for confirmed concert dates, as well as to create momentum for concert dates not yet confirmed. Further, the touring app and/or the website may be a fully integrated system through which the performers can plan a tour (e.g., domestic and/or international), interact directly with the venues to book, confirm and settle the event, efficiently handle transportation logistics, and market directly to fans and supporters to take deposits and/or sell tickets.

As used herein, a “performer,” a “venue owner,” or a “fan” may refer to any person or group of persons, or any representative(s) thereof, who use the touring app. Therefore, it is understood that a performer may include, for example, members of a band, members of a comedy troop, a manager or agent of a performer, etc. Similarly, a venue owner may refer to a venue contact person, a venue manager, a venue administrator, etc. Also, a “fan” may refer to a fan club member of a band, a ticket buyer purchasing bulk amounts of tickets, etc.

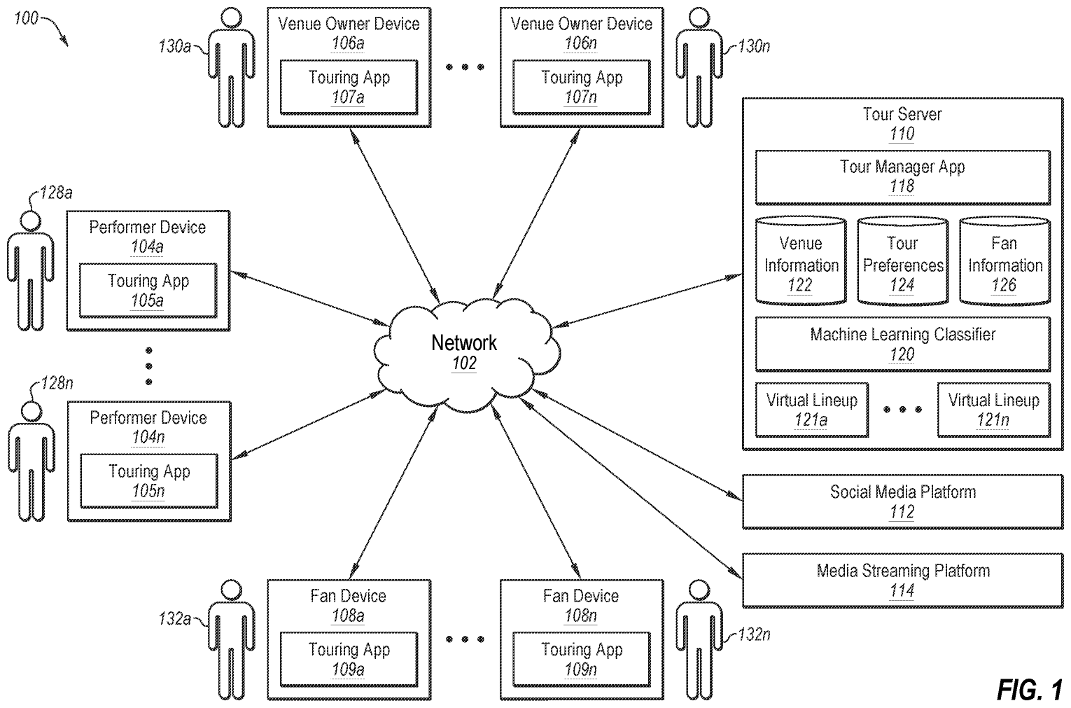

Turning to the figures, FIG. 1 illustrates an example system 100 configured for facilitating tours using a touring app. The system 100 may include a network 102, a performer devices 104a-104n, venue owner devices 106a-106n, fan devices 108a-108n, a tour server 110, a social media platform 112, and a media streaming platform 114.

In some embodiments, the network 102 may be configured to communicatively couple the performer devices 104a-104n, the venue owner devices 106a-106n, the fan devices 108a-108n, the tour server 110, the social media platform 112, and the media streaming platform 114 to one another as well as to other network devices using one or more network protocols, such as the network protocols available in connection with the World Wide Web. In some embodiments, the network 102 may be any wired or wireless network, or combination of multiple networks, configured to send and receive communications between systems and devices. In some embodiments, the network 102 may include a Personal Area Network (PAN), a Local Area Network (LAN), a Metropolitan Area Network (MAN), a Wide Area Network (WAN), a Storage Area Network (SAN), the Internet, a telecommunications network, a cellular network, a Voice over IP (VoIP) network, or some combination thereof.

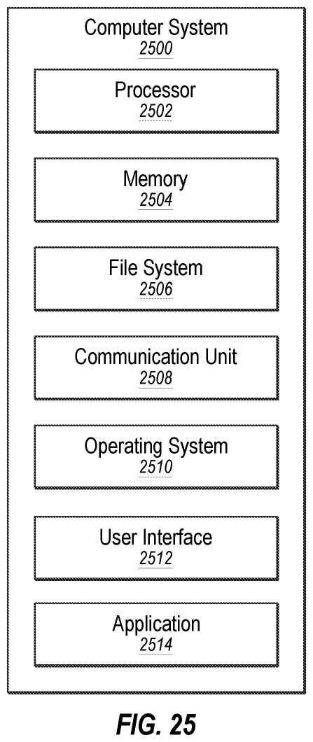

In some embodiments, each of the performer devices 104a-104n, the venue owner devices 106a-106n, and the fan devices 108a-108n may be any computer system capable of communicating over the network 102 and capable of facilitating tours in connection with touring apps 105a-105n, 107a-107n, and 109a-109n running thereon, examples of which are disclosed herein in connection with the computer system 2500 of FIG. 25. For example, the touring apps 105a-105n running on the performer devices 104a-104n may be used by performers 128a-128n to facilitate the performers 128a-128n going on tour on particular dates to particular venues. Similarly, the touring apps 107a-107n running on the venue owner devices 106a-106n may be used by venue owners 130a-130n to facilitate the booking of their venues for tours on particular dates by the performers 128a-128n. Further, the touring apps 109a-109n running on the fan devices 108a-108n may be used by fans 132a-132n to facilitate searching for shows, payment of deposits, and the subsequent purchase of tickets, for tours of the performers 128a-128n at venues of the venue owners 130a-130n on particular dates.

In some embodiments, the tour server 110 may be any computer system capable of communicating over the network 102 and capable of facilitating tours in connection with a tour manager app 118 and the touring apps 105a-105n, 107a-107n, and 109a-109n, examples of which are disclosed herein in connection with the computer system 2500 of FIG. 25. The tour server 110 may host the tour manager app 118. The tour manager app 118 may facilitate the exchange of data between the touring apps 105a-105n, 107a-107n, and 109a-109n. For example, the tour manager app 118 may send data to, and receive data from, the venue owners 130a-130n via the touring apps 107a-107n, and also store related data in, and retrieve related data from, a venue information database 122. Similarly, the tour manager app 118 may send data to and receive data from the performers 128a-128n via the touring apps 105a-105n, and also store related data in, and retrieve related data from, a tour preferences database 124. Further, the tour manager app 118 may send data to and receive data from the fans 132a-132n via the touring apps 109a-109n, and also store related data in, and retrieve related data from, a fan information database 126. The tour manager app 118 may further facility tours using the touring apps 105a-105n, 107a-107n, and 109a-109n to facilitate one or more tours.

For example, in some embodiments, the tour manager app 118 may employ data in the databases 122, 124, and 126 and a machine learning classifier 120 to automatically generate virtual lineups 121a-121n for a potential tour by one of the performers 128a-128n, which may include booking venues of the venue owners 130a-130n and taking deposits and selling tickets to the fans 132a-132n. In these embodiments, the machine learning classifier 120 may be continually trained over time to automatically and increasingly accurately project a number of the fans 132a-132n who will purchase tickets (or a number of tickets that will be purchased for the fans 132a-132n), and a performer revenue for one of the performers 128a-128n (e.g., the performer 128a), for each of the venues in a virtual lineup of venues for a potential tour of the performer 128a. This relatively accurate projection of ticket sales and performer revenue on a venue-by-venue basis may enable the performer 128a to select venues for the potential tour that are most likely to attract the most fans for the performer 128a and/or to generate the most revenue for the performer 128a. This relatively accurate projection may therefore allow the performer 128a to determine in advance the financial viability of which venues to book on which dates. Further, this relatively accurate projection may also allow the performer 128a to cut out some or all of the middlemen (e.g., booking agents, promoters, managers, etc.) to reduce the costs of a tour and increase the performer revenue and the venue revenue from the tour.

Modifications, additions, or omissions may be made to the system 100 without departing from the scope of the present disclosure. In some embodiments, the system 100 may include additional components similar to the components illustrated in FIG. 1 that each may be configured similarly to the components illustrated in FIG. 1 (e.g., the social media platform 112 may include multiple social media platforms, the media streaming platform 114 may include multiple media streaming platforms, the tour server 110 may include multiple servers, etc.). Also, in some embodiments, the functionality of the touring apps 105a-105n, 107a-107n, and 109a-109n and the tour manager app 118 may be implemented instead in one or more websites and/or in some combination of one or more apps and one or more websites.

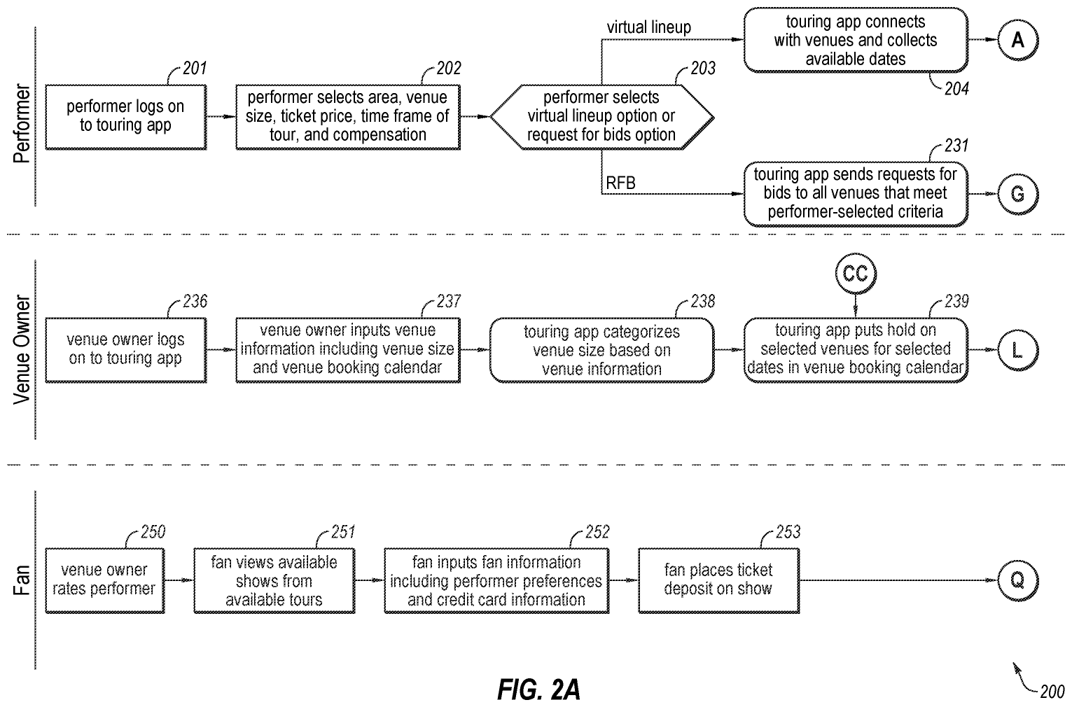

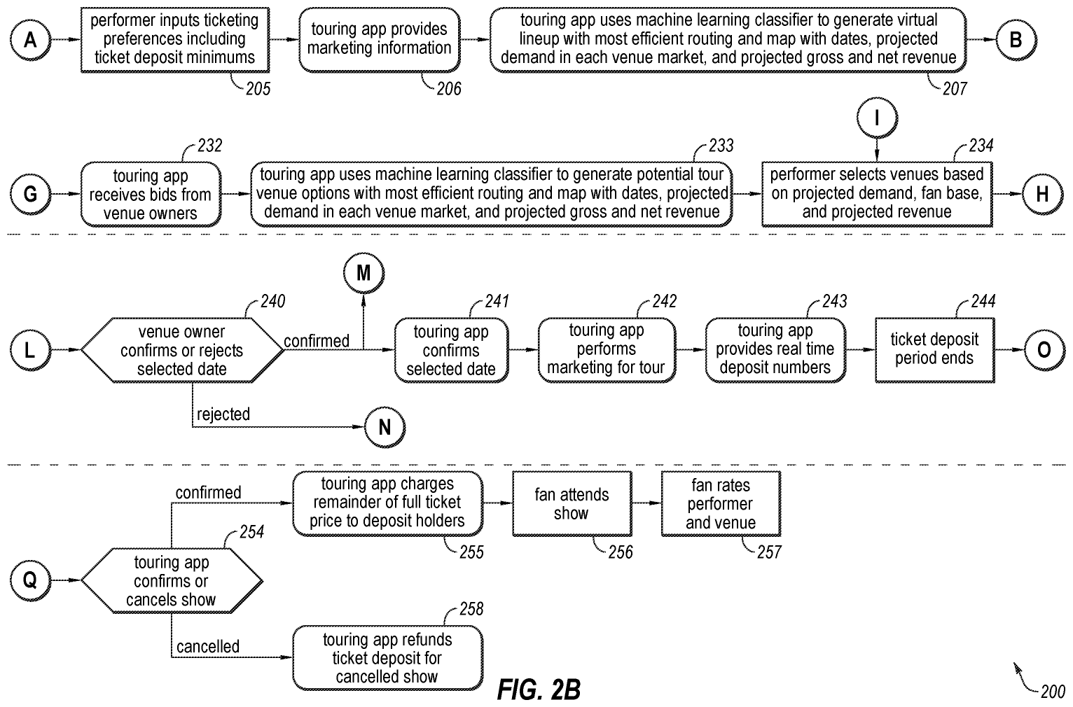

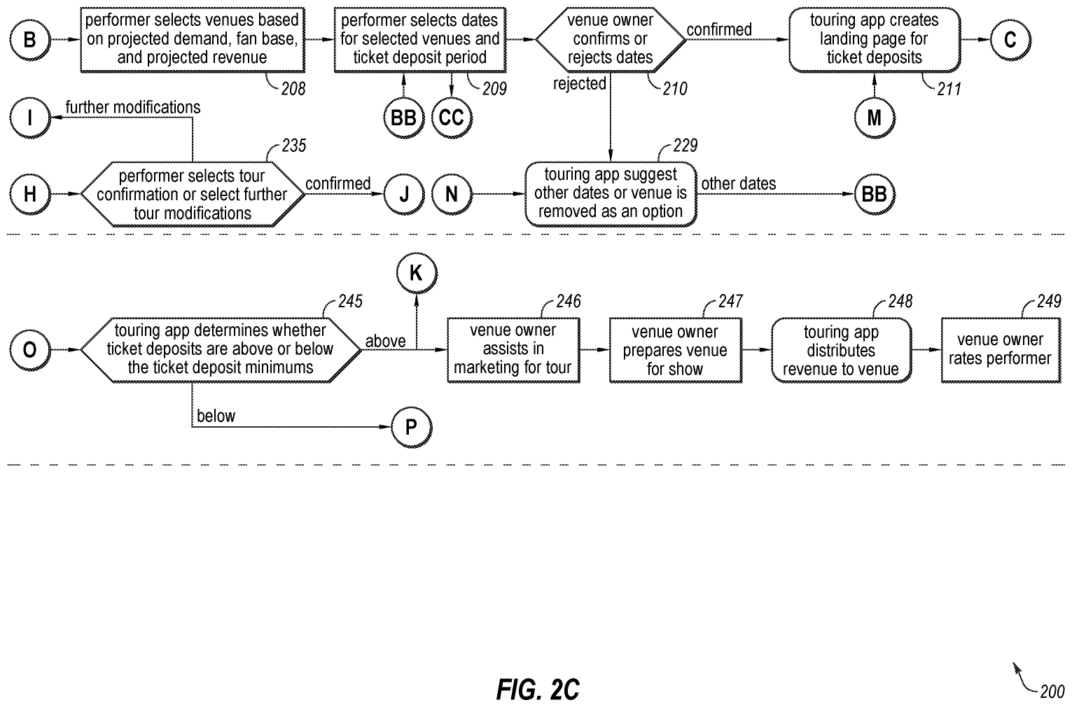

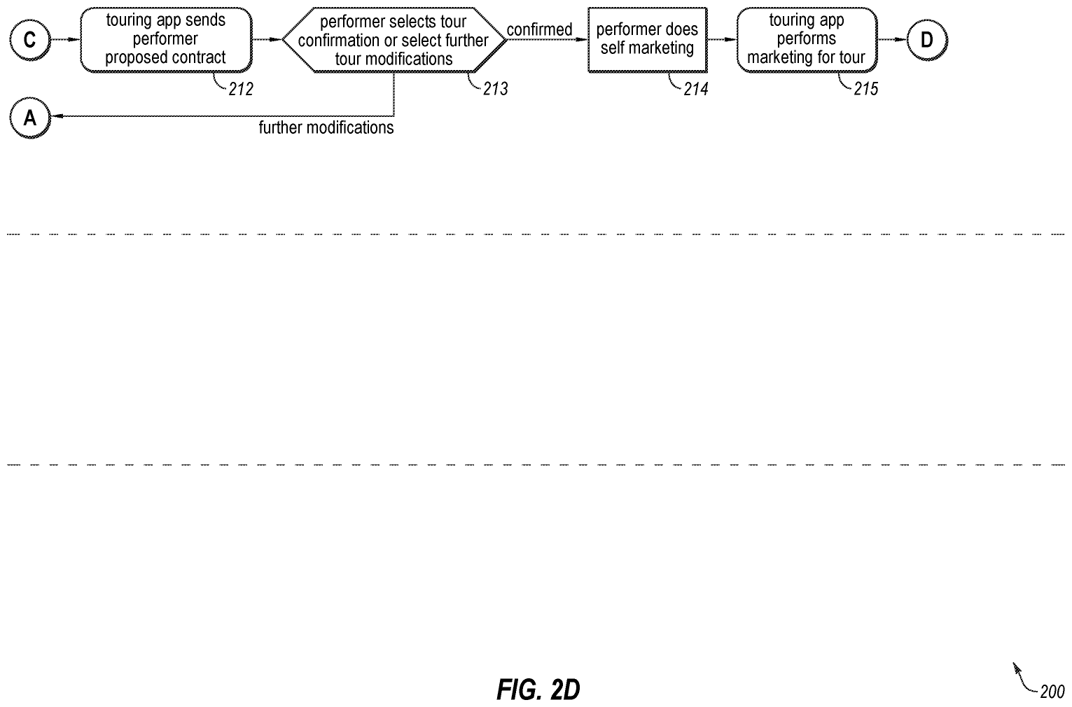

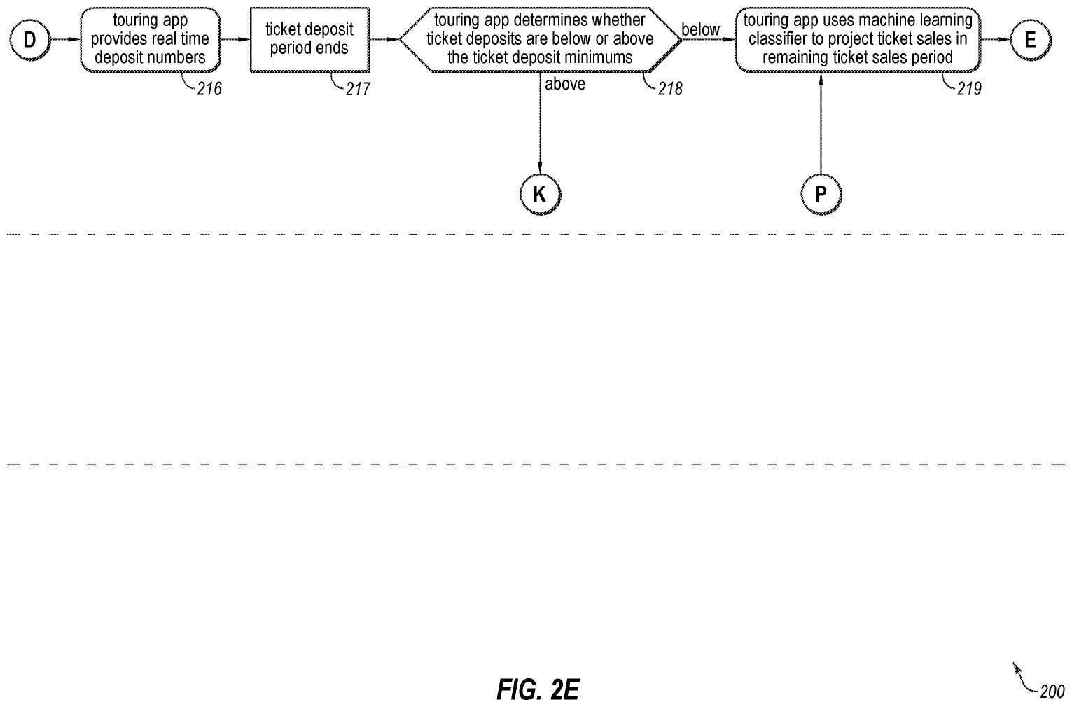

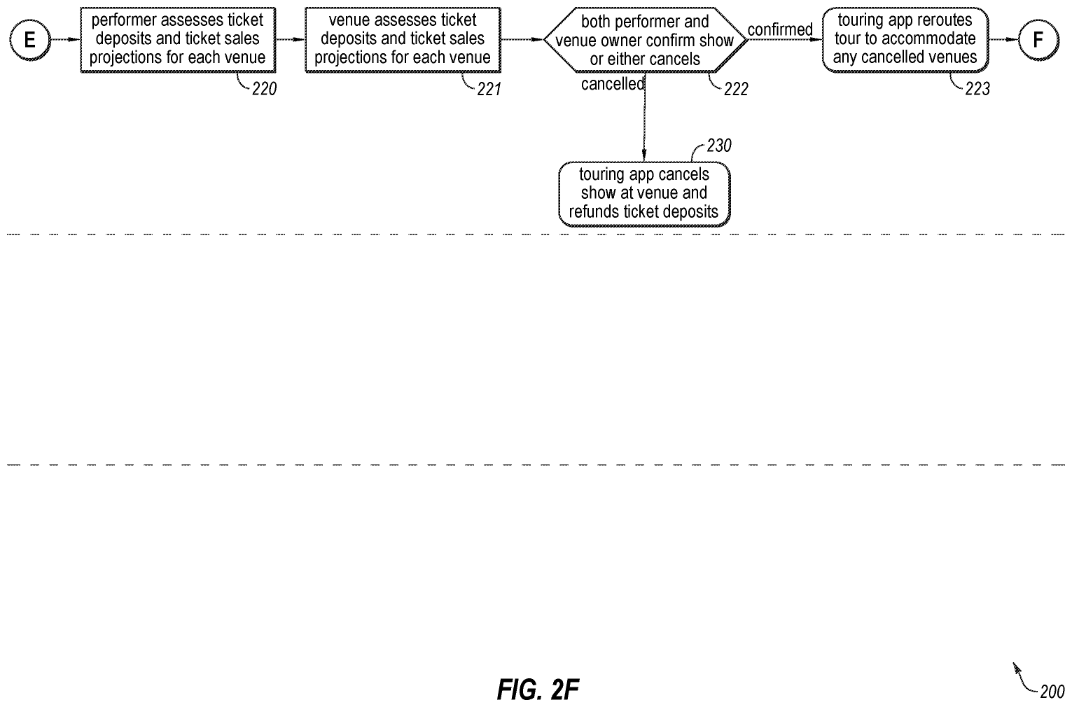

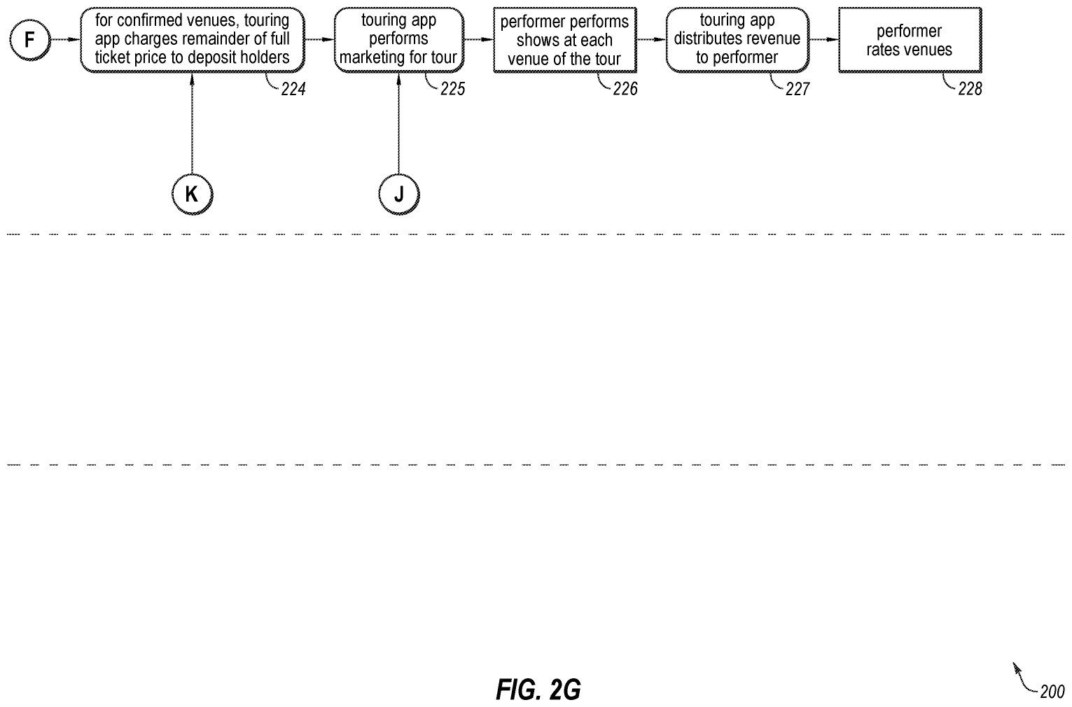

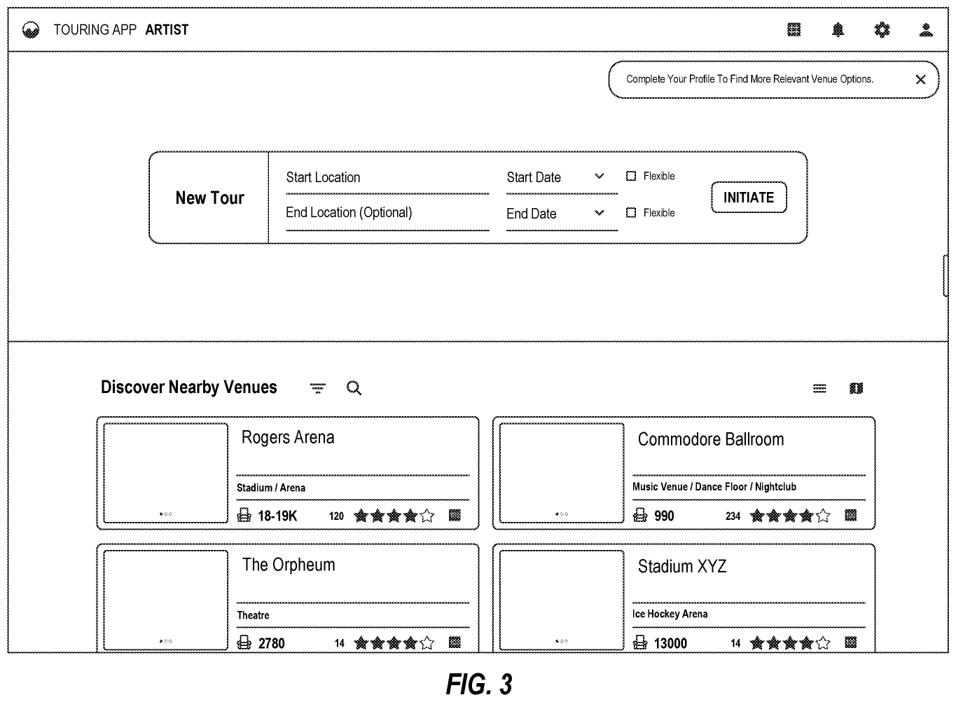

FIGS. 2A-2G are a flowchart of an example method 200 for facilitating a tour using a touring app. FIGS. 3-23 illustrate various screens of a touring app. The method 200 may be performed, in some embodiments, by a device or system, such as by any of touring apps 105a-105n, 107a-107n, and 109a-109n and the tour manager app 118 of FIG. 1 (e.g., using the screens of FIGS. 3-23), or by some combination thereof, or by some other device or system. In these and other embodiments, the method 200 may be performed by one or more processors based on one or more computer-readable instructions stored on one or more non-transitory computer-readable media. The method 200 will now be described in connection with FIGS. 1-23.

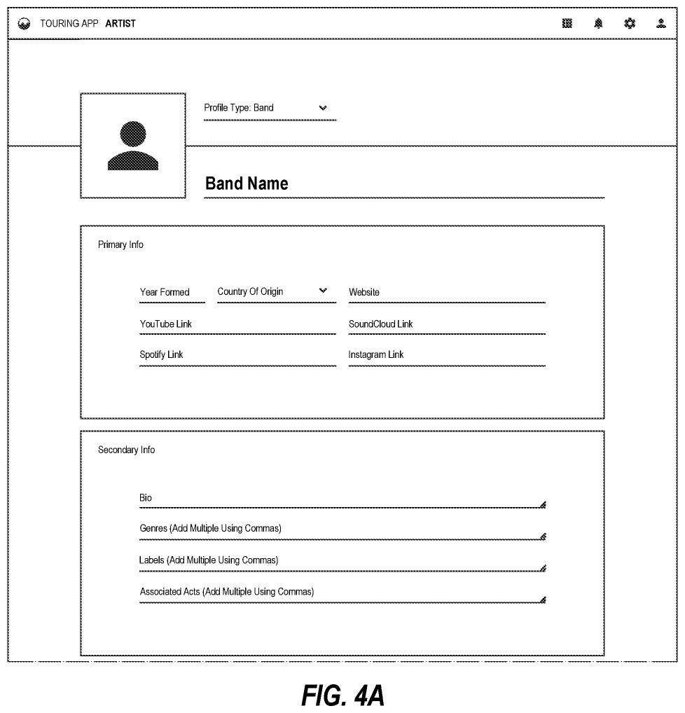

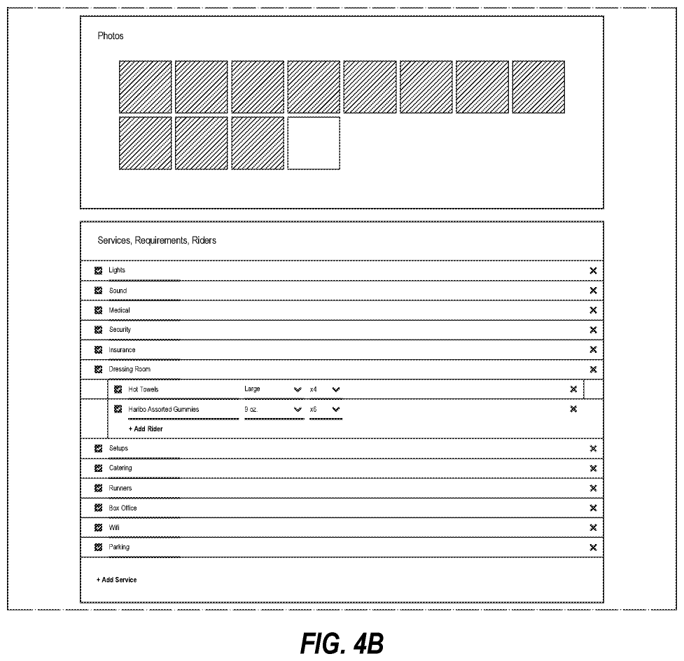

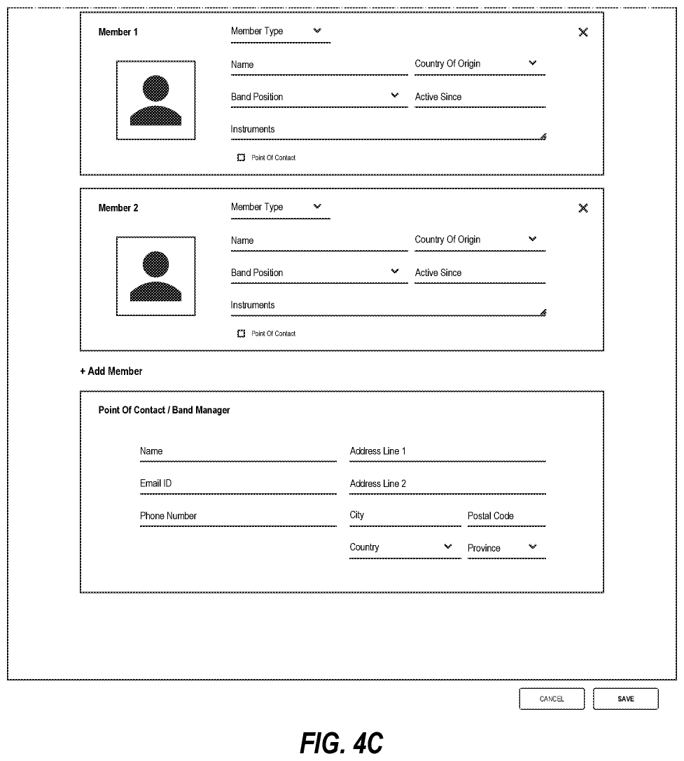

At action 201, a performer may log on to a touring app. For example, the performer 128a may log on, at action 201, to the touring app 105a with a username and password or other form of logon credential(s) or authentication. In addition to logging on to the touring app 105a, the performer 128a may additionally input performer profile information into the touring app 105a using the screen of FIGS. 4A-4C. For example, as disclosed in FIG. 4A, the performer 128a may input a profile photo, a performer type (e.g., band, stand-up comedian, motivational speaker, etc.), a name (e.g., band name, stand-up comedian name, motivational speaker name, etc.), the year the performer group was formed, the country of origin of the performer, a website of the performer 128a, and links to YouTube, SoundCloud, Spotify, and Instagram accounts for the performer. Further, as disclosed in FIG. 4A, the performer 128a may input a bio, a list of genres, a list of labels, and a list of associated acts for the performer 128a. Also, as disclosed in FIG. 4B, the performer 128a may input photos and a list of services, requirements, and riders for the performer, including services, requirements, and/or riders related to lights, sounds, medical, security, insurance, dressing room, setups, catering, runners, box office, Wi-Fi, parking, etc. Further, as disclosed in FIG. 4C, the performer 128a may input information related to each member of a performer group including a profile photo, a member type (e.g., vocalist, drummer, guitarist, etc.), a name, a country of origin, a band position, an active since date, and a list of instruments played. Also, as disclosed in FIG. 4C, the performer 128a may input information related to a point of contact/band manager, including name, address, email, phone number, etc.

At action 202, the performer may select an area, a venue size, a ticket price, a time frame of a potential tour, and a compensation. For example, using the screen of FIG. 3 of the touring app 105a, the performer 128a may input, at action 202, a geographic area based on a start location and an optional end location (e.g., town/city or state/province) and a start date and end date for the tour (which may be designated as flexible dates), and then the performer 128a may select the initiate button. Upon selecting the initiate button, various venues may appear in a list of venues on the screen of FIG. 3. In addition, based on the touring app 105a determining the current location of the performer 128a (e.g., using a GPS location of the performer device 104a), a list of venues may automatically appear on the screen of FIG. 3 that includes venues that are nearby (e.g., within some threshold distance such as 500 miles or 1000 miles). Further, using the screen of FIG. 5 of the touring app 105a (e.g., which may appear by selecting the initiate button on the screen of FIG. 3), the performer 128a may select, at action 202, a target ticket price for a potential tour, an expected audience size for the potential tour (e.g., an expected number of tickets that will be purchased by fans for each venue), a tour genre for the potential tour, a closing date for taking deposits for the potential tour, a minimum rating for venues on the potential tour, a deal type for the potential tour (e.g., a deal that pays the performer 128a a fixed fee, a deal that pays the performer 128a a percentage of revenue, a deal that pays the performer 128a a fixed fee plus a percentage of revenue, etc.), whether the potential tour should be optimized for new artists, whether the potential tour should include opening act opportunities, various mandatory or optional services for the potential tour (e.g., lights, sound, medical, security, insurance, dressing room, setups, catering, runner, box office, etc.), and various travel options (e.g., maximum distance traveled each day, maximum interval between two shows, preferred mode of travel, and preferred countries). In some embodiments, the tour manager app 118 may determine, based on the cities specified for a potential tour, a minimum length of time required to complete the tour and then allow the performer 128a to select any date range that is greater than or equal to the determined minimum length of time.

At action 203, the performer may select a virtual lineup option or a request for bids (RFB) option. If the performer selects the virtual lineup option at action 203, the method 200 may continue with action 204. If the performer selects the RFB option at action 203, the method may continue with action 231. For example, the performer 128a may select, at action 203, a virtual lineup option or an RFB option. If the performer 128a desire to gauge interest of the fans 132a-132n on a venue-by-venue basis prior to committing to each venue of a potential tour, the performer 128a may select the virtual lineup option. The virtual lineup option may allow for performers who are less well known to build and confirm their virtual lineup before committing to a tour, as well as providing a direct marketing channel for both high profile and lesser known performers to take deposits for and later sell tickets to their most loyal fans.

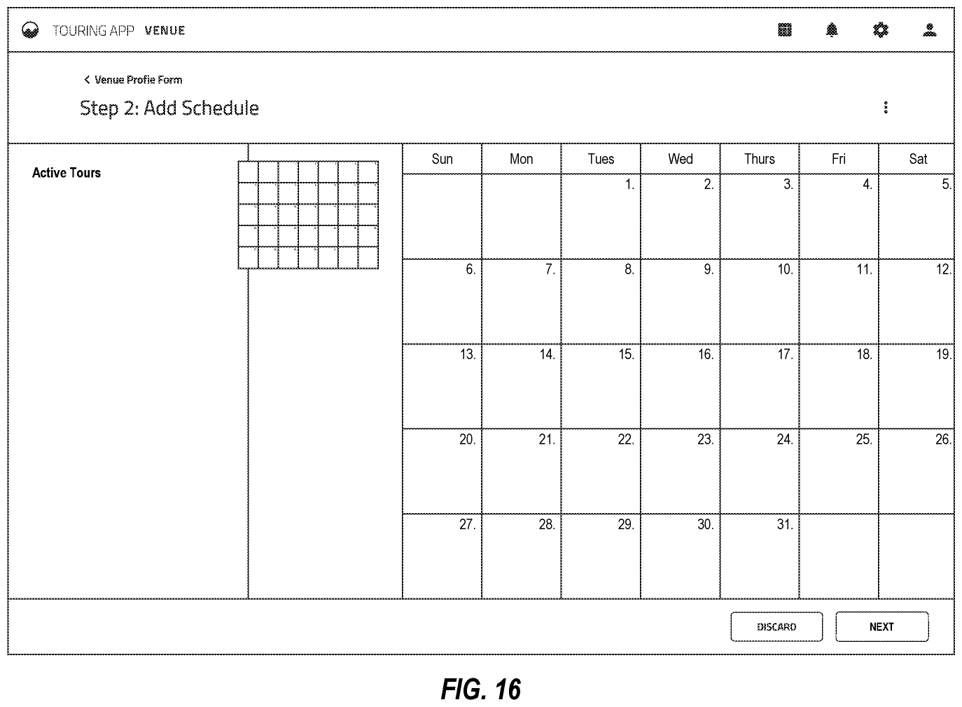

At action 204, the touring app may connect with venues and may collect available dates. For example, the tour manager app 118 may, at action 204, connect with venues and may collect available dates, such as from the venue information database 122. These available dates may have been previously entered by venue owners 130a-130n using the screen of FIG. 16, for example.

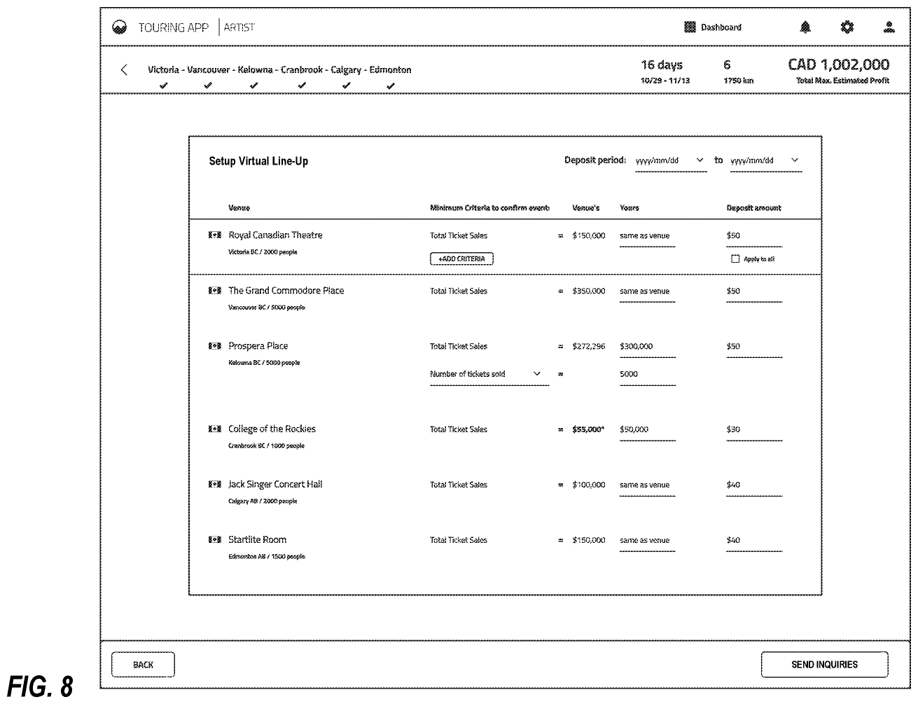

At action 205, the performer may input ticketing preferences including ticket deposit minimums. For example, using the screen of FIG. 8 of the touring app 105a, the performer 128a may input, at action 205, ticketing preferences including ticket deposit amounts (e.g., which may correspond to ticket deposit minimums), such as deposits of $20, $30, $40, or $50. Ticketing preferences may also include a minimum number of tickets, whether all tickets will cost the same or will have varying prices (e.g., for proximity pricing), whether tickets will have dynamic pricing (e.g., with tickets getting more expensive as the time of the show approaches), whether tickets may be resold (e.g., via scalping), etc.

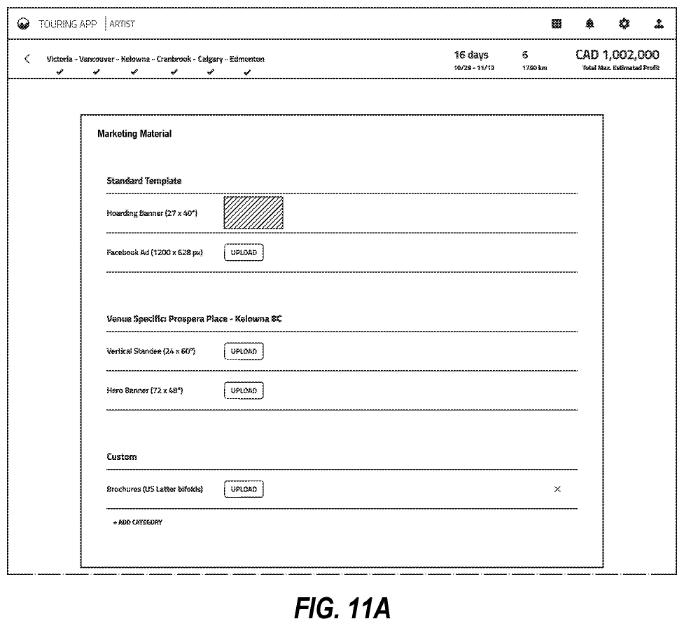

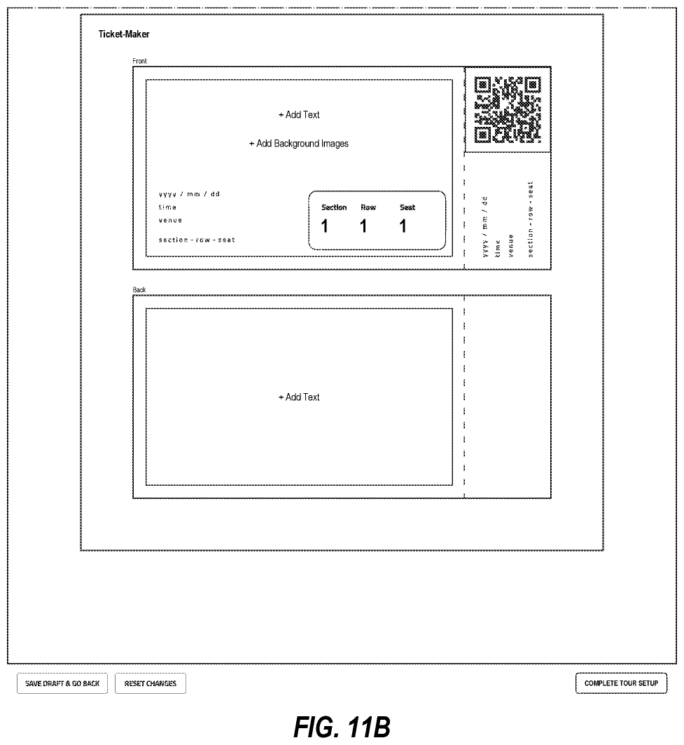

At action 206, the touring app may provide marketing information. For example, using the screen of FIGS. 11A-11B, the tour manager app 118 may provide, at action 206, marketing material such as templates for a hording banner or billboard and a Facebook ad, venue specific marketing materials such a vertical standee and a hero banner, custom marketing material such as brochures, and a ticket-maker that may provide a template to design the front and the back of a ticket. Further, the tour manager app 118 may provide past examples of automated digital marketing campaigns with examples of ads and conversion data. Also, the tour manager app 118 may provide comparable anonymous conversion and sales data of a similar genre. The performer 128a may then select an automated marketing campaign provided by the tour manager app 118 (e.g., which may involve a fee paid by the performer 128a) and/or may select self marketing of the potential tour. For the automated marketing campaign, the performer 128a may input graphic designs for ads based on templates and available sizing provided by the tour manager app 118. Also, sponsorship examples may be provided as well as examples of how to encourage individuals and organizations within the fan base of the performer 128a to place a deposit on a ticket at their closest venue to support the performer and get the concert date confirmed.

At action 207, the touring app may use a machine learning classifier to generate a virtual lineup with a most efficient routing and a map with dates, a projected demand in each venue market, and a projected gross and net revenue. For example, using the screen of FIG. 5, the tour manager app 118 may use, at action 207, the machine learning classifier 120 to generate a virtual lineup of potential tours. For example, as disclosed in FIG. 5, the tour manager app 118 may use, at action 207, the machine learning classifier 120 to generate three virtual tours, namely a first virtual tour from Victoria to Los Angeles lasting 20 days, a second virtual tour from Victoria to Edmonton lasting 16 days, and a third virtual tour from Victoria to Los Angeles lasted 9 days. Each of these three virtual tours may be generated by the machine learning classifier 120 with a most efficient routing and a map with dates, a projected demand in each venue market, and a projected gross and net revenue. For example, as disclosed in FIG. 5, the second virtual tour from Victoria to Edmonton lasting 16 days may include shows in six cities (namely Victoria, Vancouver, Kelowna, Cranbrook, Calgary, and Edmonton), with a maximum estimated earnings of $1,002,000. In some embodiments, each of the virtual tours may be plotted on a map, potentially with travel modes and travel times for travelling between cities, to allow the performer 128a to visualize the travel that would be involved in each of the virtual tours.

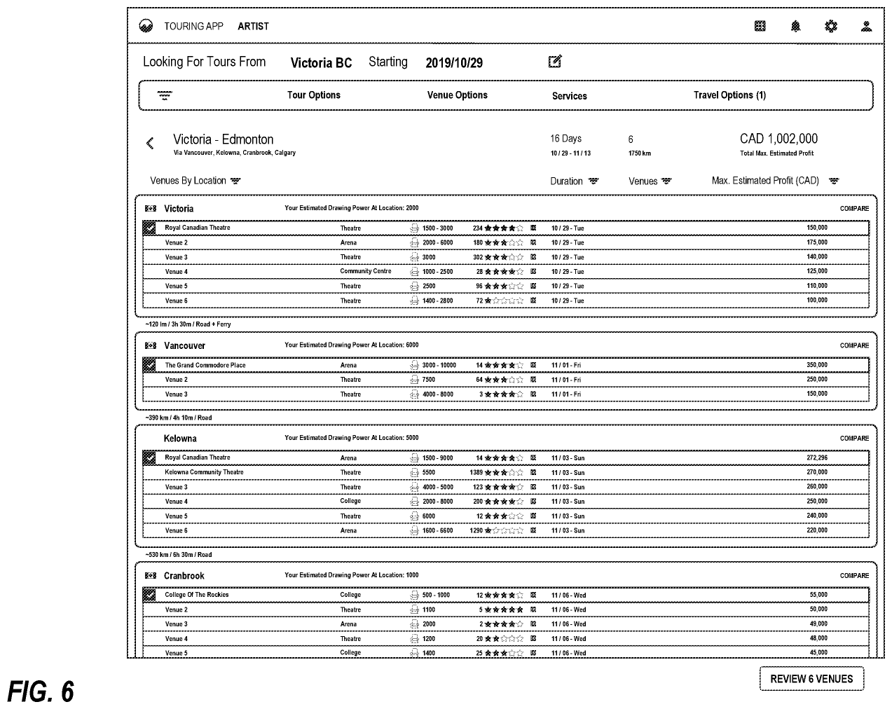

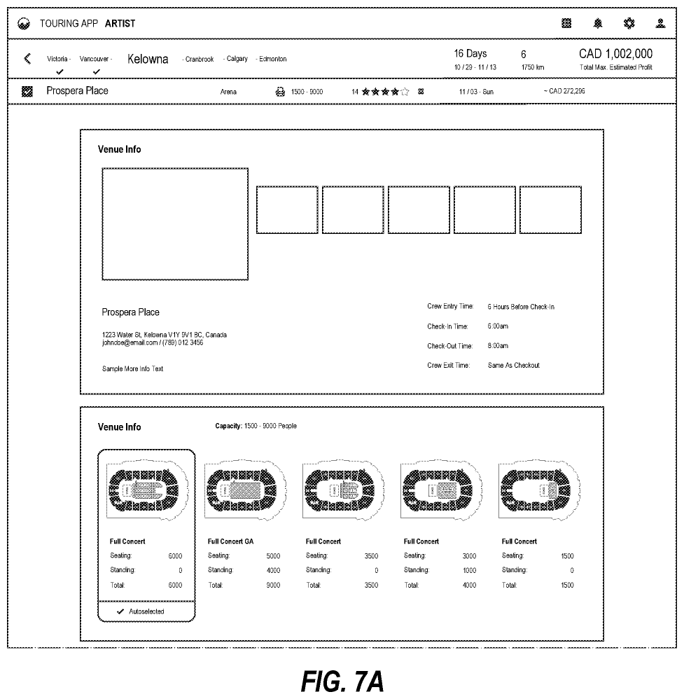

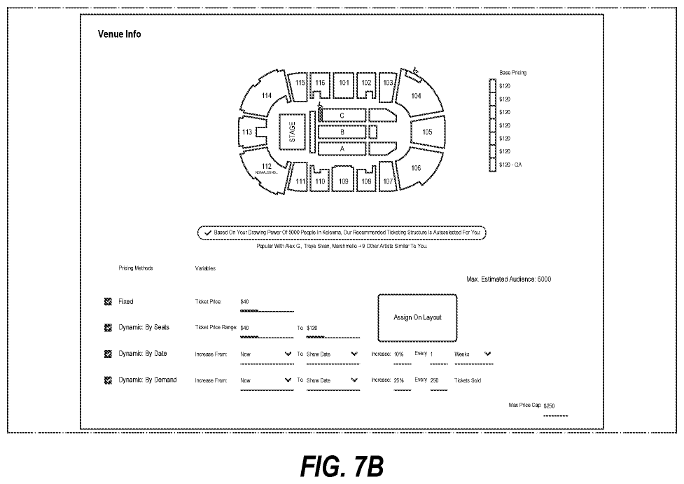

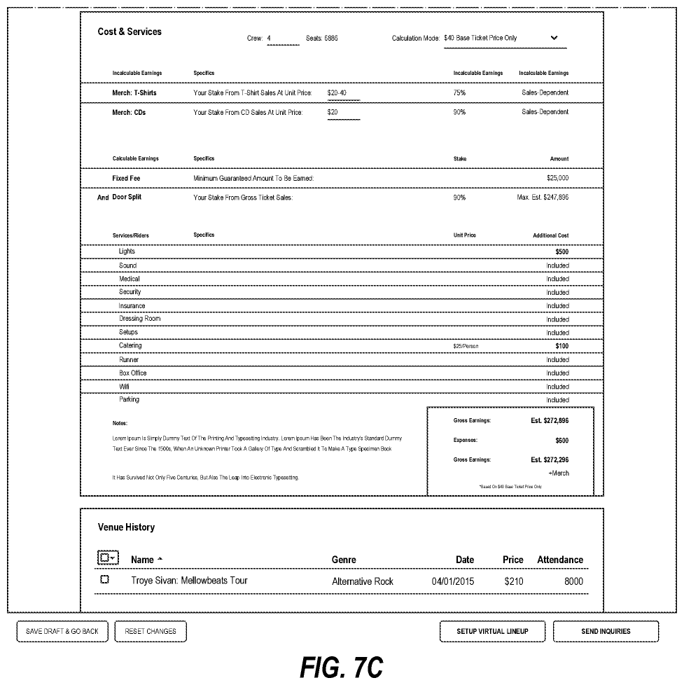

At action 208, the performer may select venues based on projected demand, fan base, and projected revenue. For example, using the screen of FIG. 6 of the touring app 105a, the performer 128a may select, at action 208, venues for each of the six cities of the second virtual tour. The performer 128a may base their selection on the projected maximum estimated profits for each venue (which may be determined by the machine learning classifier 120 by determining the projected demand for tickets), as well as any fan base of the performer 128a near the venue. Further, using the screen of FIGS. 7A-7C of the touring app 105a, the performer 128a may select a venue based on information specific to each venue, such as photos of the venue, the venue name, the venue address, the crew entry time, the check-in time, the check-out time, the crew exit time, the venue seating configurations, the pricing methods for the venue (e.g., fixed pricing, dynamic pricing by seats, by date, or by demand), and costs and services such as for t-shirts, CDs, lights, sound, medical security, insurance, dressing room, setups, catering, runner, box office, Wi-Fi, parking, etc. As disclosed in FIG. 7C, the information specific to a venue may include a history of other performers who performed at the venue, the dates of such performances, the price of tickets for such performances, and the number of attendees at such performances. Further, using the screen of FIG. 8 of the touring app 105a, the performer 128a may select venues for the second virtual tour (e.g., the tour from Victoria to Edmonton), as well as specify minimum ticket sales criteria and minimum ticket deposit amounts for each venue. The performer 128a may also select dates for shows at selected venues, as wells as ends dates for the taking of deposits at each selected venue.

At action 210, the venue owner may confirm or reject the dates. If the venue owner confirms the dates at action 210, the method 200 may continue with action 211. If the venue owner rejects the dates at action 210, the method 200 may continue with action 229.

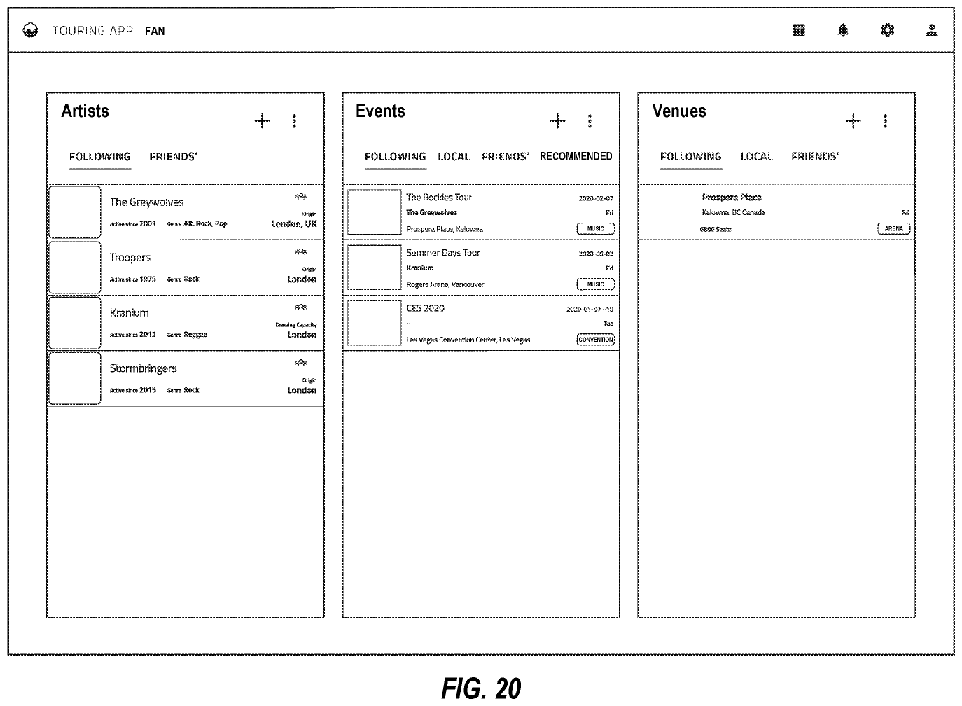

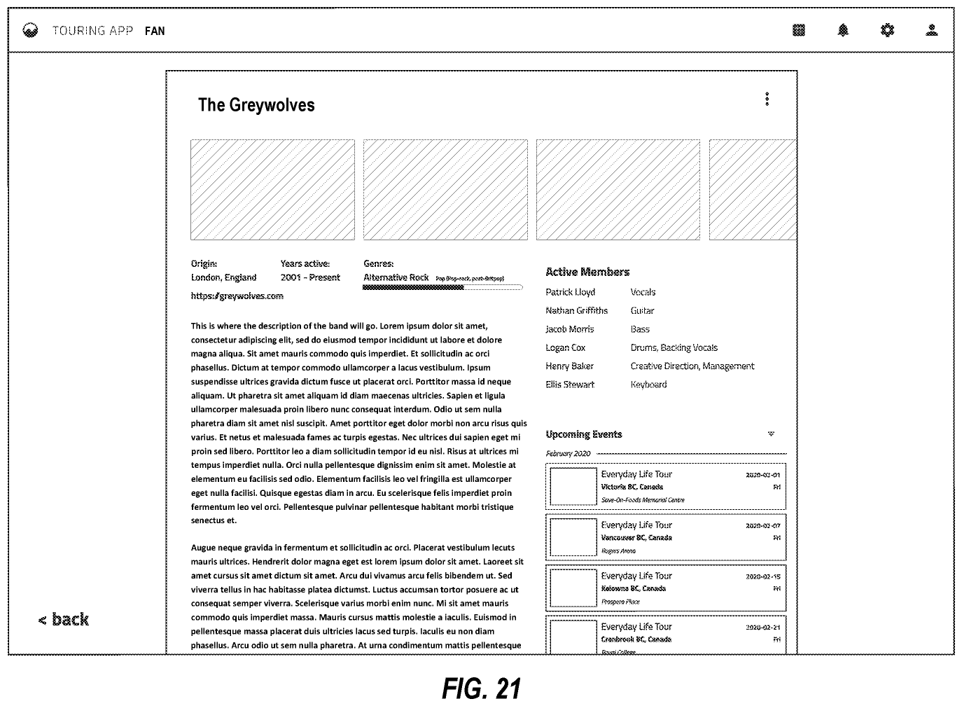

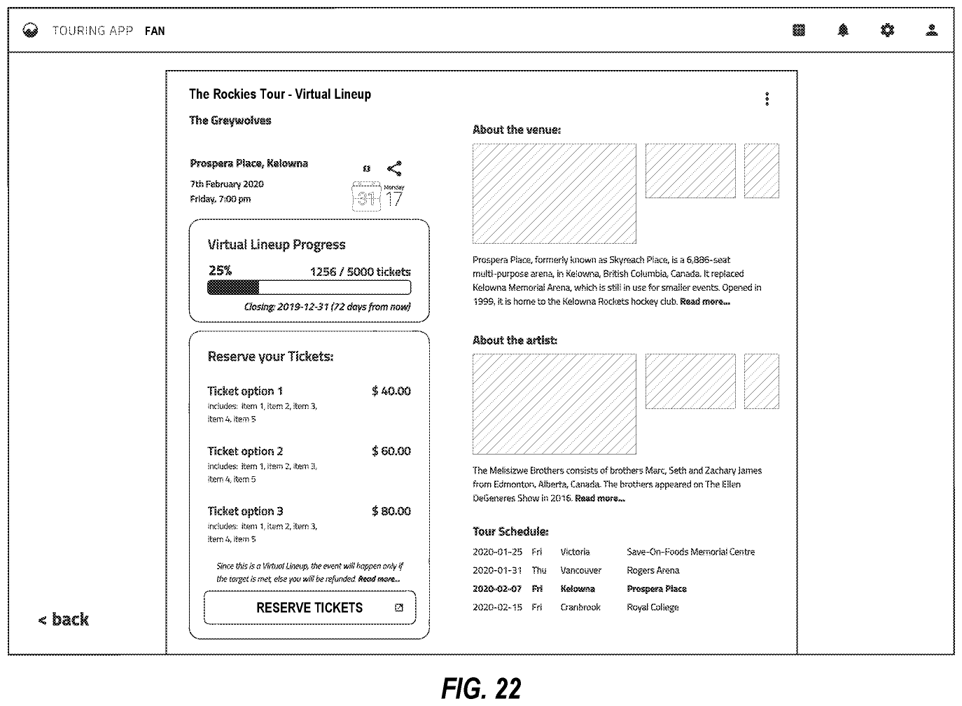

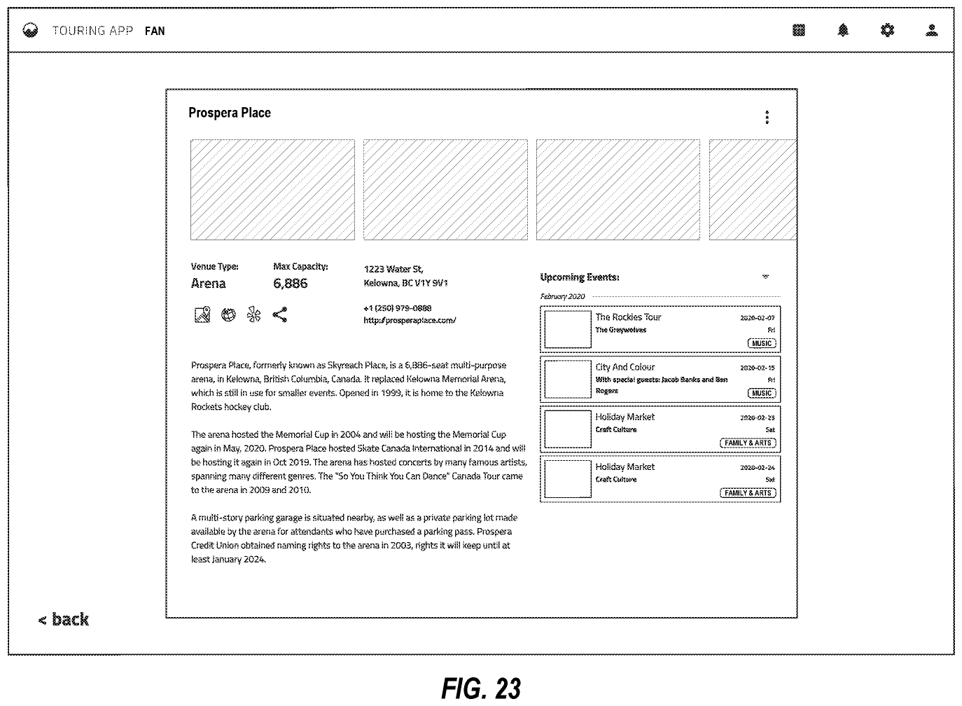

At action 211, the touring app may create a landing page for ticket deposits. For example, using the screens of FIGS. 20, 21, 22, and 23, the tour manager app 118 may create, at action 211, landing pages for ticket deposits. For example, as disclosed in FIG. 21, the fans 132a-132n may use the touring apps 109a-109n to search for potential tickets to shows of tours by performer, by tour, or by venue. When a fan (e.g., the fan 132a) selects a particular performer on the screen of FIG. 20, the fan 132a may arrive at the landing page disclosed in FIG. 21 for the performer 128a (e.g., for the Greywolves) where the fan 132a may learn more about the performer 128a and may place a deposit on a ticket for an upcoming show by the performer 128a. Alternatively, when the fan 132a selects a particular tour on the screen of FIG. 20, the fan 132a may arrive at the landing page disclosed in FIG. 22 for the virtual tour of the performer 128a (e.g., for the Rockies Tour for the Greywolves) where the fan 132a may learn more about the virtual tour and may place a deposit on a ticket (e.g., by selecting the reserve tickets button) for an upcoming show by the performer 128a that is tentatively (e.g., subject to receiving a sufficient number of deposits) included in the virtual tour. Alternatively, when the fan 132a selects a particular venue on the screen of FIG. 20, the fan 132a may arrive at the landing page disclosed in FIG. 23 for the venue (e.g., for the Prospera Place) where the fan 132a may learn more about the venue and may place a deposit on a ticket for an upcoming show at the venue. Once the fan 132a has placed a deposit on a show (e.g., by selecting the reserve tickets button, and agreeing to a deposit amount paid for with a credit or debit card, for example), a contractual arrangement may come into existence for the fan 132a to purchase the ticket (e.g., pay the remainder of the full ticket price) if the show is ultimately booked (e.g., if enough fans place a sufficient number of deposits).

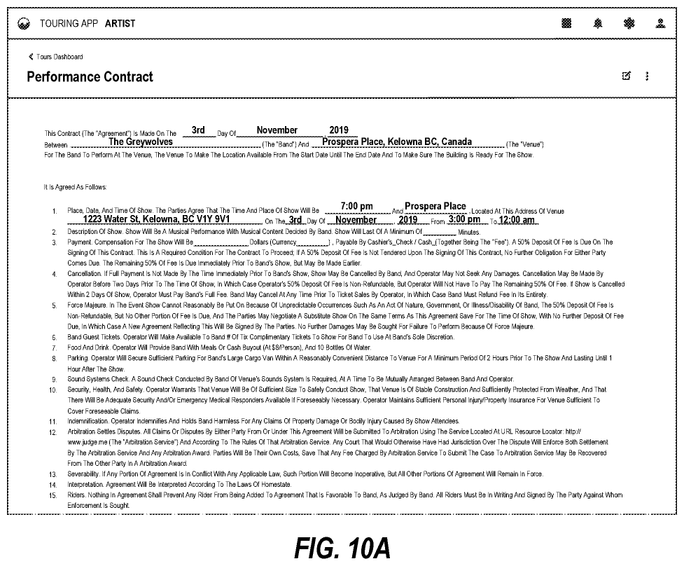

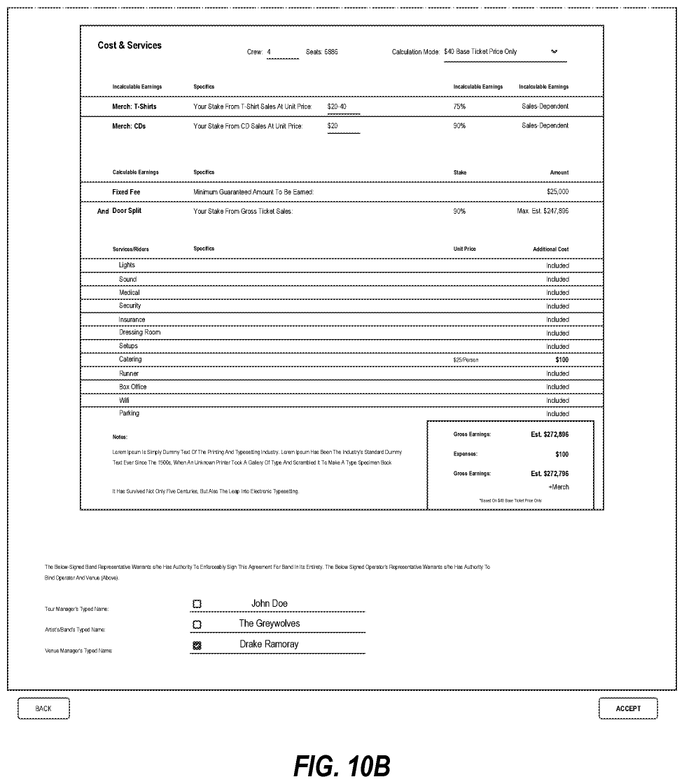

At action 212, the touring app may send the performer a proposed contract. For example, using the screens of FIGS. 10A-10C, the tour manager app 118 may send, at action 212, the performer 128a (e.g., the Greywolves) a proposed contract for a particular venue (e.g., Prospera Place). The tour manager app 118 may also send the performer 128a a proposed routing for the tour based on venue acceptance, projected revenues, projected number of ticket sales per market as well as overall, total projected costs based on standard venue show costs, marketing costs, a date marketing can proceed, and a date deposits will close.

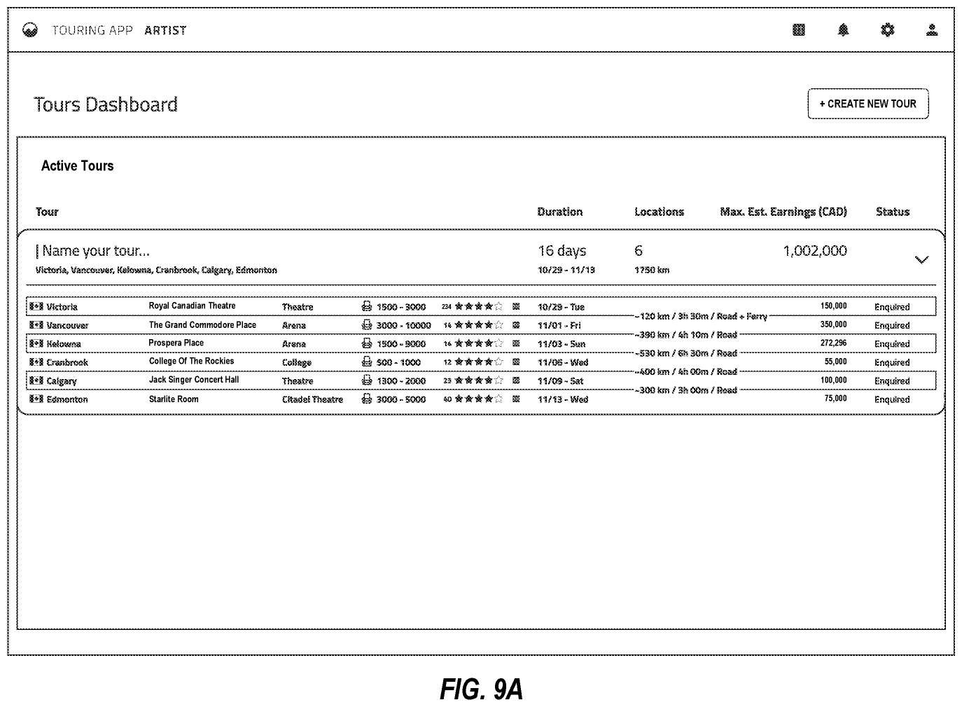

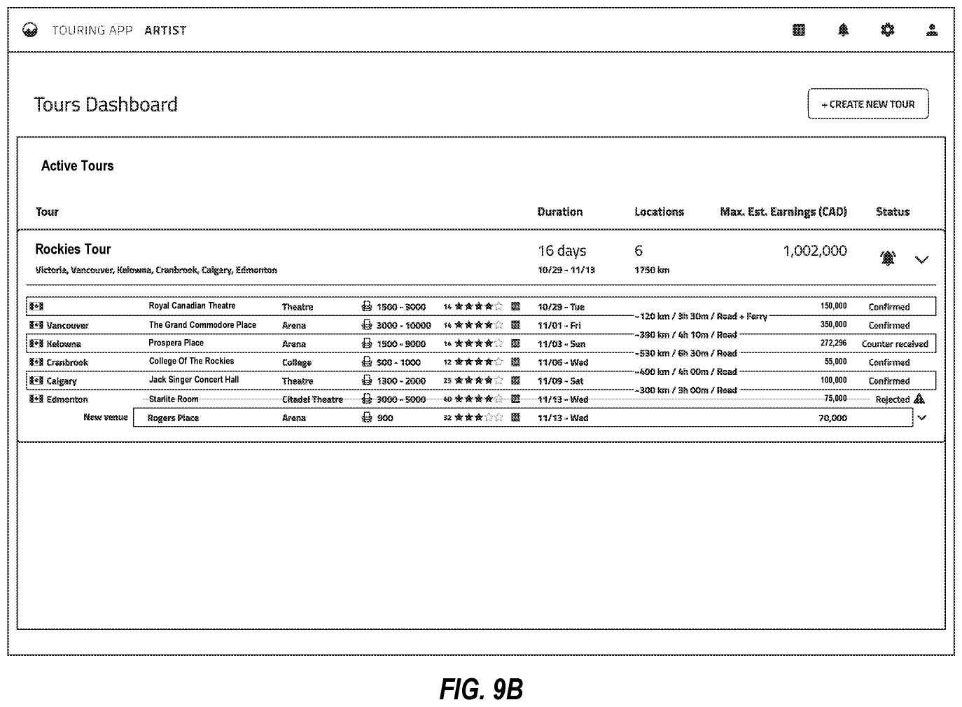

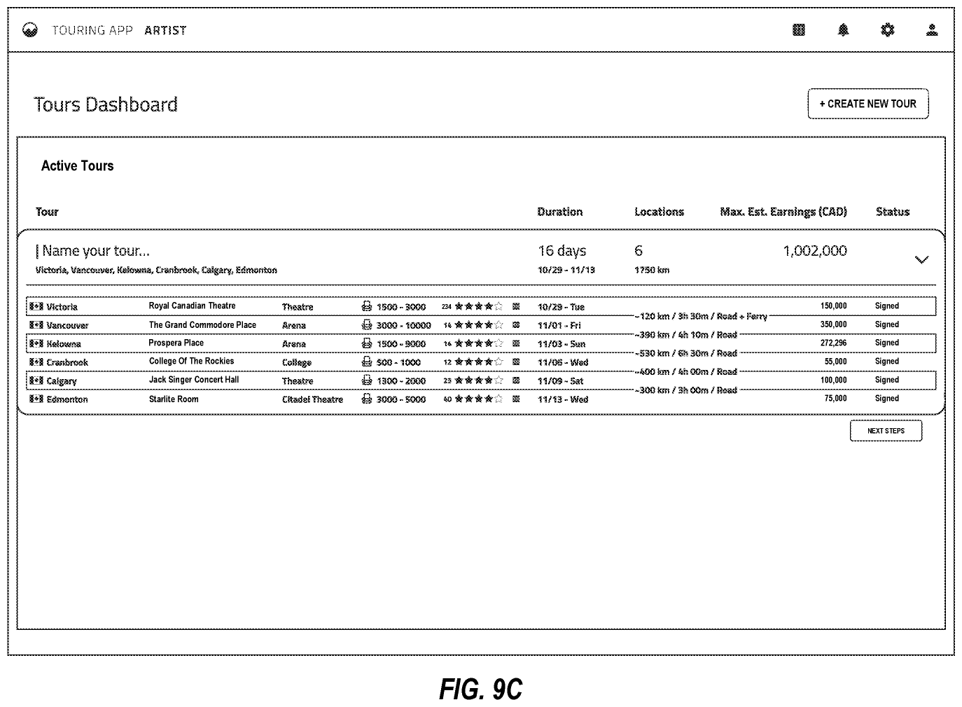

At action 213, the performer may select a tour confirmation or may select further tour modifications. If the performer selects the tour confirmation at action 213, the method 200 may continue with action 214. If the performer selects the further tour modifications at action 213, the method 200 may return to action 205. For example, using the screen of FIGS. 9A-9C of the touring app 105a, the performer 128a may, at action 213, either confirm each of the venues in the virtual tour (e.g., at which point the status of each venue is changed to confirmed) or may make further tour modifications (e.g., leaving the status of each venue is listed as enquired, counter received, or rejected). For example, as disclosed in FIG. 9B, the performer 128a may receive a counter offer from the venue owner in Kelowna (e.g., from the venue owner of Prospera Place), and may reject the initial venue chosen for Edmonton (e.g., may reject the venue Starlite Room). Where a venue is rejected, the touring app 105a, may propose a new venue for that city (e.g., may propose the venue Rogers Place for the city of Edmonton). As disclosed in FIG. 9C, once a contract is signed for each of the venues in the virtual tour, the status of the venue may be changes by the touring app 105a to signed. Further, one the contract is signed, a contractual arrangement may come into existence for the performer 128a to perform, and for each of the venue owners 130a-130n to make their venues available on the agreed upon dates and to make sure their venues are ready for the shows.

At action 214, the performer may do self marketing. For example, the performer 128a may do self marketing at action 214 by advertising for the tour on a fan club website, on social media accounts of the performer 128a, through sponsors of the performer 128a, by sending emails to an email list of the performer 128a (e.g., which may include fans 132a-132n who have opted in to receive emails from the performer 128a via the touring apps 109a-109n), and by word-of-mouth advertising by the performer 128a.

At action 215, the touring app may perform marketing for the tour. For example, using the screens of FIGS. 20, 21, 22, and 23, the tour manager app 118 may perform, at action 215, marketing for the virtual tour. In some embodiments, the tour manager app 118 may automatically create digital ads from graphic designs received from the performer 128a, and may automatically place the ads through the social media platform 112 (e.g., Facebook, Instagram, Google, etc.) and the media streaming platform 114 (e.g., Spotify, YouTube, etc.), as well as automatically send the ads to members of a fan club of the performer 128a (e.g., via email, via text, via the touring app, etc.).

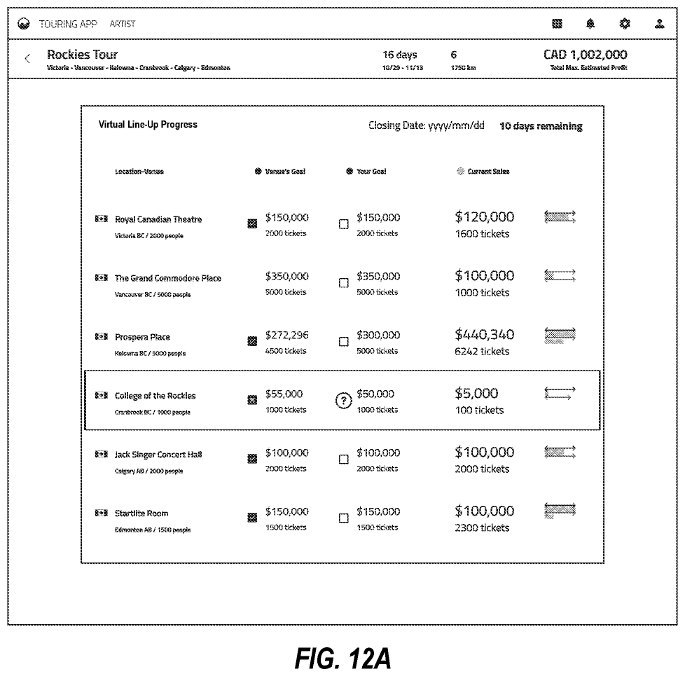

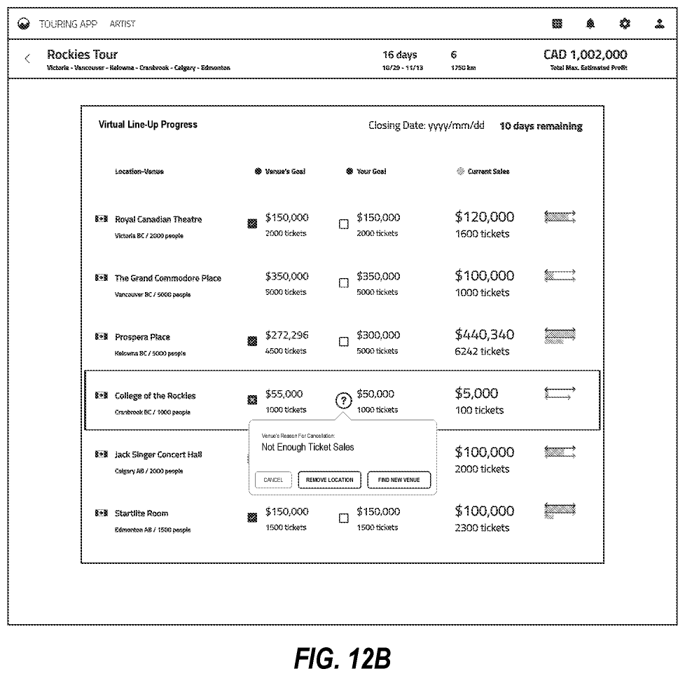

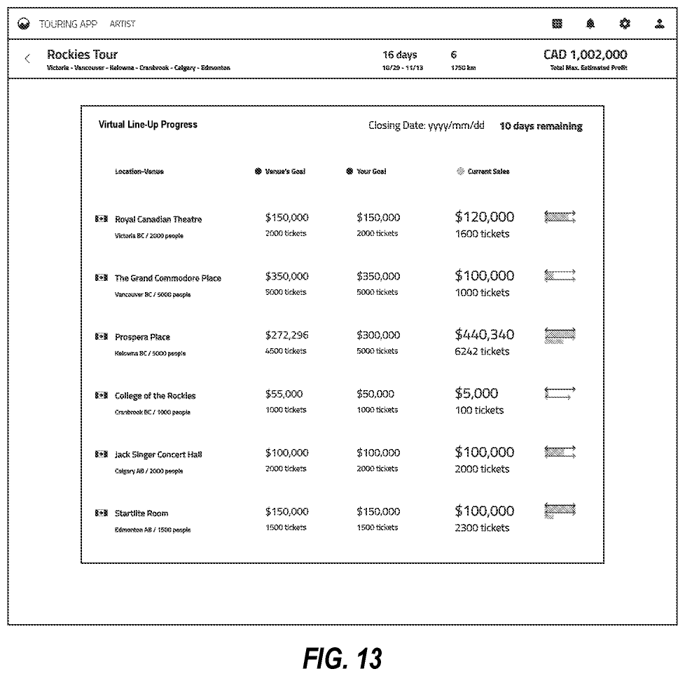

At action 216, the touring app may provide real time deposit numbers. For example, using the screens of FIGS. 12A-12B and 13, the tour manager app 118 may provide, at action 216, real time deposit numbers for a virtual tour (e.g., for the Rockies Tour). For example, as disclosed in FIG. 12A, the tour manager app 118 may provide to the performer 128a and to the venue owners 130a-130n each venue's goal for tickets deposits, the ticket deposit goal of the performer 128a for each venue, and the current deposits numbers for each venue, along with a chart showing whether each of the goals has been reached or has been exceeded. The screens of FIGS. 12A-12B and 13 may be displayed to both the performer 128a in the touring app 105a, as well as to the venue owner 130a-130n in the touring apps 107a-107n.

At action 217, the ticket deposit period may end. For example, as disclosed in the screens of FIGS. 12A-12B and 13, the ticket deposit period may have a closing date (e.g., which may correspond to the end of the deposit period).

At action 218, the touring app determines whether the ticket deposits are below or above the ticket deposit minimums. If the ticket deposits are below the ticket deposit minimums at action 218, the method 200 may continue with action 219. If the ticket deposits are above the ticket deposit minimums at action 218, the method 200 may continue with action 224. For example, as disclosed in the screens of screens of FIGS. 12A-12B and 13, the tour manager app 118 may determine, at action 218, that ticket deposits are at or above the ticket deposit minimums for some venues (e.g., for Prospera Place, Jack Singer Concert Hall, and Starlite Room), but are below the ticket deposit minimums for some venues (e.g., for Royal Canadian Theatre, the Grand Comodore Place, and College of the Rockies).

At action 219, the touring app may use the machine learning classifier to project ticket sales in a remaining ticket sales period. For example, the tour manager app 118 may use, at action 219, the machine learning classifier 120 to project ticket sales in a remaining ticket sales period. For example, if there are 50 days between the present day and the show for a venue (or between the present day and a ticket sales cutoff date for the show), the machine learning classifier 120 may project ticket sales for the venue for the next 50 days.

At action 220, the performer may assess ticket deposits and ticket sales projections for each venue. At action 221, the venue may assess ticket deposits and ticket sales projections for each venue. For example, using the screens of FIGS. 12A-12B and 13, the performer 128a may assess at action 220, and each of the venue owners 130a-130n may assess at action 221, ticket deposits for each venue. Further, the tour manager app 118 may further provide the performer 128a and the venue owners 130a-130n with the ticket sales projections for each venue that were projected at action 219.

At action 222, both the performer and the venue may confirm the show or either may cancel. If both the performer and the venue owner confirm the show at action 222, the method 200 may continue with action 223. If either of the performer or the venue owner cancels the show at action 222, the method may continue with action 230. For example, using the screen of FIG. 12B, the performer 128a or the venue owner 130a of the venue College of the Rockies may cancel the venue at action 222 due to, for example, insufficient ticket deposits. Alternatively, the performer 128a and the venue owner 130a may both confirm the show despite currently having insufficient ticket deposits, perhaps with the hope that prior to the show sufficient tickets will be sold to make the show worthwhile.

At action 223, the touring app may reroute the tour to accommodate any cancelled venues. For example, using the screen of FIG. 12B, the tour manager app 118 may reroute the tour to accommodate the cancelled venue College of the Rockies.

At action 224, for confirmed venues, the touring app may charge the remainder of a full ticket price to deposit holders. For example, where fans 132a-132n were each charged a deposit of $20 for a $100 ticket, the tour manager app 118 may charge the remainder of the full ticket price (e.g., the remaining $80) to the fans 132a-132n.

At action 225, the touring app may perform marketing for the tour. For example, the tour manager app 118 may perform, at action 215, marketing for the virtual tour (e.g., similar to action 215).

At action 226, the performer may perform shows at each venue of the tour. For example, as the date for each show of the tour arrives, the performer 128a may perform, at action 226, the show at the corresponding venue.

At action 227, the touring app may distribute revenue to the performer. For example, the tour manager app 118 may distribute, at action 227, revenue to the performer 128a, either through the touring app 105a, or via some other financial app or system, such as via direct deposit in a bank account of the performer 128a.

At action 228, the performer may rate the venues. For example, the performer 128a may rate each of the venues at action 228, which may result in or contribute to the 1-5 star ratings of the venues disclosed in FIG. 3 and/or FIG. 7A (e.g., to create a reputation for the venues that can be used by other performers). In some embodiments, this rating may be based on the experience at the venue, the efficiency of production and overall set up, the performance of the key venue contact person, and the integrity in the settlement.

At action 229, the touring app may suggest other dates or the venue may be removed as an option. If the touring app may, at action 220, suggest other dates for a venue may be removed from a virtual tour.

At action 230, the touring app may cancel a show at a venue and may refund ticket deposits. For example, using the screen of FIG. 12B, the tour manager app 118 may cancel the show at the College of the Rockies in response to either the performer 128a or the venue owner 130a selecting the cancel button or remove location button.

At action 231, the touring app may send requests for bids to all venues that meet performer-selected criteria. For example, the tour manager app 118 may send, at action 231, requests for bids to all venue owners 130a-130n via the touring apps 107a-107n where the corresponding venues meet the criteria (e.g., seating capacity, dates, etc.) selected by the performer 128a.

At action 232, the touring app may receive bids from venue owners. For example, the tour manager app 118 may receive, at action 232, bids from the venue owners 130a-130n via the touring apps 107a-107n. In some embodiments, each of the venue owners 130a-130n may have until a specified RFB close date to confirm availability of their venue and complete a standardized venue bid response form, which may include (1) fee and fee options, (2) terms of agreement (including building costs, show costs, and guarantees), (3) a listing of all dates the venue is available within the specified tour date range provided by the performer 128a in the RFB, and (4) an agreement to hold the dates for a set number of days.

At action 233, the touring app may use a machine learning classifier to generate potential tour venue options with a most efficient routing and a map with dates, a projected demand in each venue market, and a projected gross and net revenue. For example, the tour manager app 118 may use, at action 233, the machine learning classifier 120 to generate potential tour venue options with a most efficient routing and a map with dates, a projected demand in each venue market, and a projected gross and net revenue, similar to the action 207. In some embodiments, the machine learning classifier 120 may consider all bids received and venues selected and, based on the availability of each venue and its location, may create a possible tour map and route.

At action 234, the performer may select venues based on the projected demand, a fan base, and a projected revenue. For example, the performer 128a may select, at action 234, venues based on the projected demand, a fan base, and a projected revenue, similar to the action 208. In some embodiments, the performer 128a may review a possible tour map against each venue's bid and may then eliminate any venue bids that the performer 128a does not wish to accept (e.g., based on specifics of the bid received, the venue's rating, etc.).

At action 235, the performer may select a tour confirmation or may select further tour modifications. If the performer selects a tour confirmation at action 235, the method 200 may continue with action 225. If the performer selects further tour modifications at action 235, the method may return to action 234. For example, the performer 128a may, at action 235, select a tour confirmation or may select further tour modifications, similar to the action 213.

At action 236, a venue owner may log on to the touring app. For example, the venue owner 130a may log on, at action 236, to the touring app 107a with a username and password or other form of logon credential(s) or authentication.

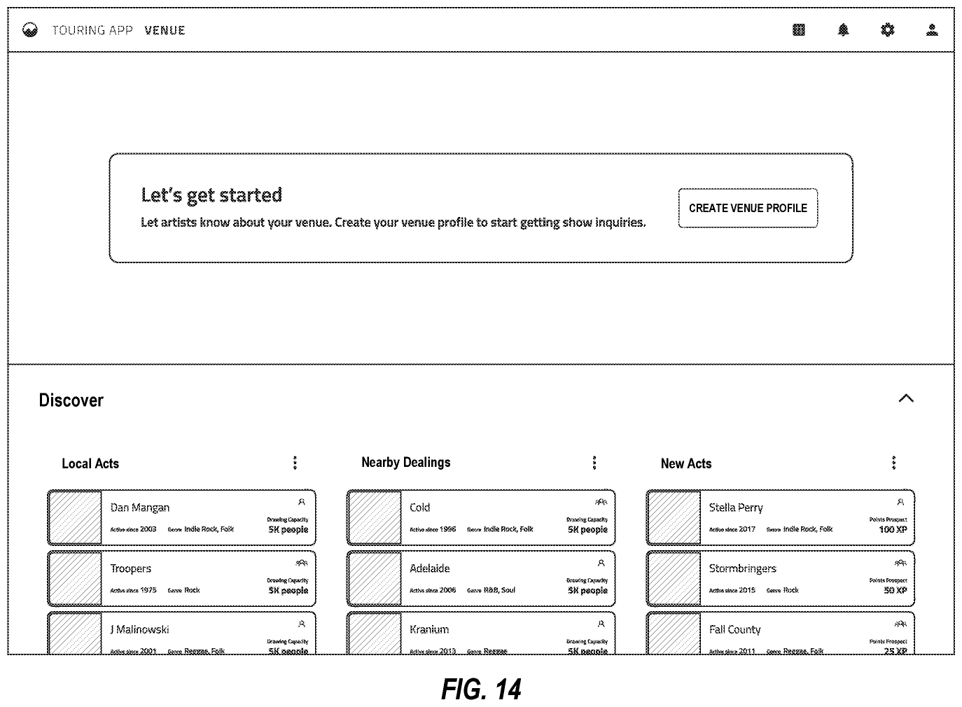

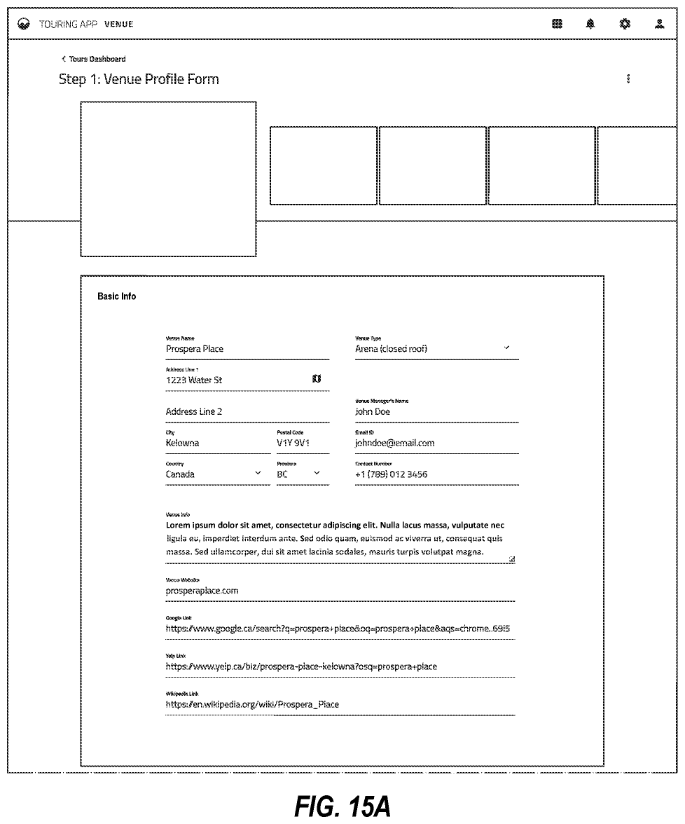

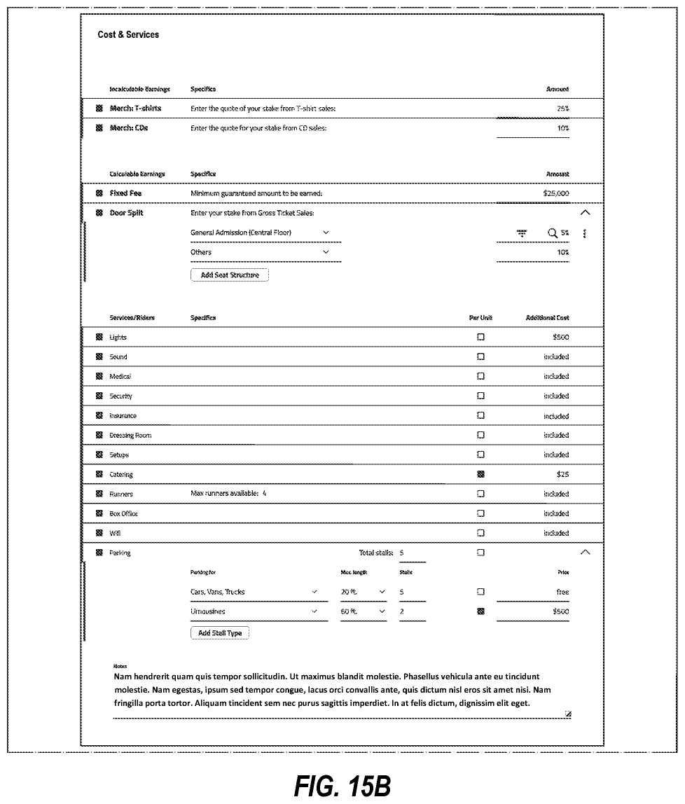

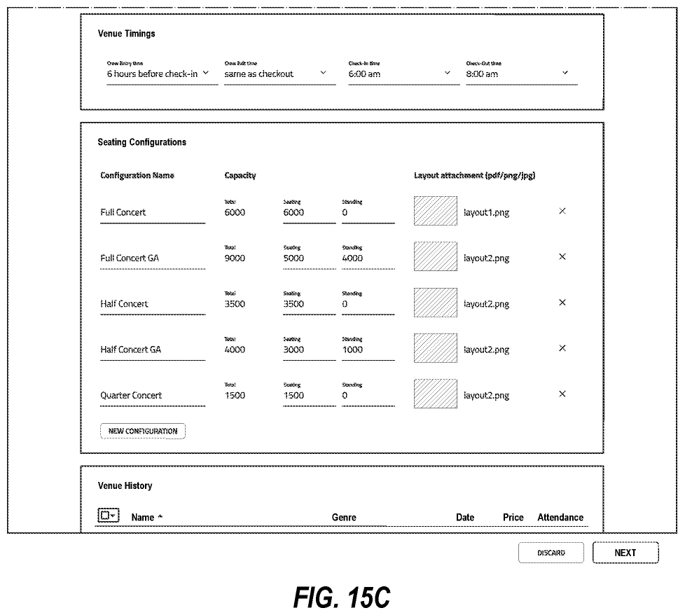

At action 237, the venue owner may input venue information including a venue size and a venue booking calendar. For example, using the screen of FIG. 14, the venue owner 130a may select the create venue profile button, which may take the venue owner 130a to the screen of FIGS. 15A-15C and then to the screen of FIG. 16, where the venue owner 130a may input, at action 237, venue information. As disclosed in FIG. 15A, this venue information may include photographs of the venue, a venue name, a venue address, a venue type (e.g., arena, stadium, amphitheater, concert hall, etc.), a venue manager's name, a venue email address, a venue contact number, a venue description, a venue website, a venue Google link, a venue Yelp link, and a venue Wikipedia link. As disclosed in FIG. 15B, this venue information may also include costs and services such as for t-shirts, CDs, fixed fees, door split, lights, sound, medical security, insurance, dressing room, setups, catering, runners, box office, Wi-Fi, parking, etc. As disclosed in FIG. 15B, this venue information may also include the crew entry time, the crew exit time, the check-in time, the check-out time, the venue seating configurations, and a history of other events held at the venue. As disclosed in FIG. 16, this venue information may also include a venue booking calendar of bookings of events for the venue. In some embodiments, the venue owner 130a may input various venue data including total number of seats, seat counts in different configurations, suggested proximity pricing for each configuration with photos and financial examples of past shows, suggested dynamic pricing with financial examples of past shows, fixed show costs based on different configurations (with a guaranteed minimum and maximum), available rigging points and max weight specifications, available show services and cost (e.g., sound, light, catering, etc.), number of change rooms available and photos of typical set up, hours or days in advance of time and date of show venue is available for rehearsal/sound check, maximum number of days unconfirmed dates can be held, available marketing specific to the venue including signage exposure outside venue, signage inside venue, ticketing data base, club seats/suites, etc., and venue contact person.

At action 238, the touring app may categorize the venue size based on the venue information. For example, the tour manager app 118 may categorize, at action 238, the venue size based on the venue information received from the venue owners 130a-130n.

At action 239, the touring app may put a hold on selected venues for selected dates in the venue booking calendar. For example, the tour manager app 118 may put, at action 239, a hold on selected venues for selected dates in the venue booking calendar, which may appear on the screen of FIG. 16.

At action 240, the venue owner may confirm or reject a selected date. If the venue owner confirms a selected date at action 240, the method 200 may continue with action 241. If the venue owner rejects a selected date at action 241, the method may return to action 229. For example, the venue owner 130a may, at action 240, confirm or reject a selected date, similar to action 210. In some embodiments, where the venue owner 130a declines a selected date, the venue owner 130a may specify the reason in the touring app 107a, which the performer 128a may or may not be able to see in the touring app 105a. If the specified reason for declining the selected date is a date conflict, the tour manager app 118 may determine that the venue owner 130a may take the show if the date is changed and might suggest dates before or after the selected date for the show. If the specified reason for declining the selected date is based on past reviews of the genre of music of the performer 128a (e.g., the venue owner 130a does not wish to hold shows for certain music genres), the tour manager app 118 may determine that the venue owner 130a is not likely to make the venue available regardless of any adjustments to the date or other parameters.

At action 241, the touring app may confirm a selected date. For example, the tour manager app 118 may confirm, at action 241, a selected date for a venue.

At action 242, the touring app may perform marketing for the tour. For example, the tour manager app 118 may perform, at action 242, marketing for the tour (e.g., similar to action 215).

At action 243, the touring app may provide real time deposit numbers. For example, the tour manager app 118 may provide, at action 243, real time deposit numbers for the virtual tour (e.g., similar to action 216).

At action 244, the ticket deposit period may end. For example, the ticket deposit period may have a closing date (e.g., similar to action 217).

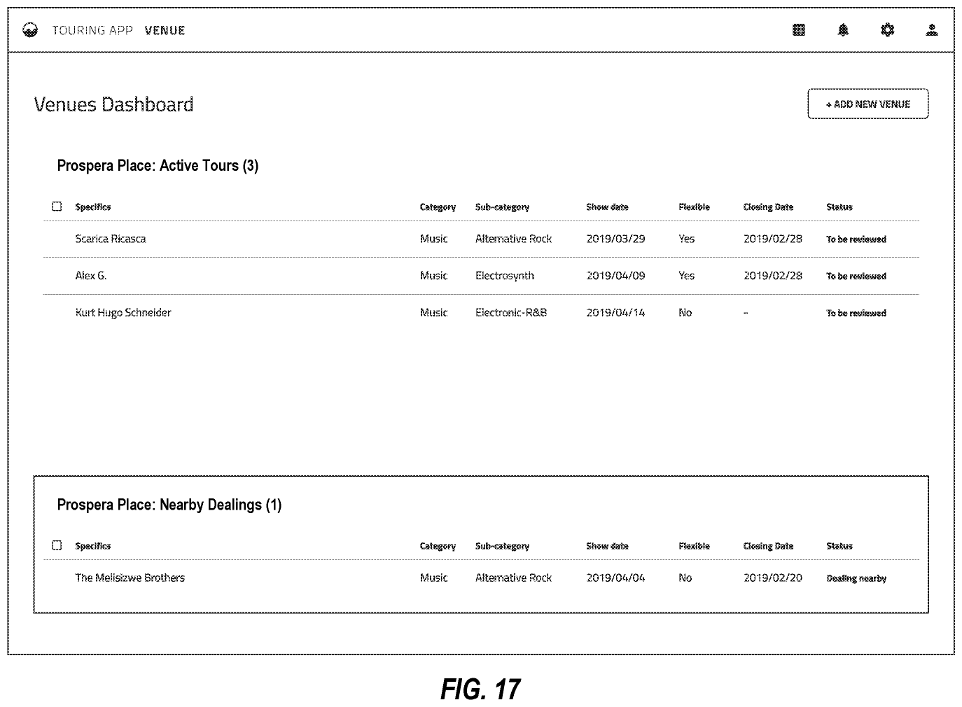

At action 245, the touring app may determine whether the ticket deposits are below or above the ticket deposit minimums. If the ticket deposits are above the ticket deposit minimums at action 245, the method 200 may continue with action 246. If the ticket deposits are below the ticket deposit minimums at action 245, the method 200 may return to action 219. For example, the tour manager app 118 may determine, at action 245, whether the ticket deposits are below or above the ticket deposit minimums (e.g., similar to action 218). Further, the venue owner 130a may monitor the status of pending ticket deposits, as well as events at nearby venues, using a venue dashboard on the screen of FIG. 17. In some embodiments, if a number of ticket deposits received is greater than or equal to the minimum number specified by the performer 128a (e.g., which may mean that all show costs will be covered by the full ticket prices based on deposits), the venue may be automatically confirmed. In some embodiments, if the number of ticket deposits received is less than the minimum number specified by the performer (e.g., which may mean that all show costs will not be covered by the full ticket prices based on the deposits), the performer 128a and/or the venue owner 130a may decide to cancel show.

At action 246, the venue owner may assist in marketing for the tour. For example, the venue owner 130a may assist, at action 246, in marketing for the tour. This marketing may include marketing on a venue website, marketing on social media accounts of the venue, the sending of emails to an email list of the venue, and advertising of the tour on billboards and/or other signage and/or programs of other shows controlled by or accessible to the venue.

At action 247, the venue owner may prepare the venue for the show. For example, the venue owner 130a may prepare, at action 247, the venue for the show (e.g., by setting up the seating configuration, the stage, the concessions and merchandise sale stations, etc.).

At action 248, the touring app may distribute revenue to the venue. For example, the tour manager app 118 may distribute, at action 248, revenue to the venue owner 130a, either through the touring app 107a, or via some other financial app or system, such as via direct deposit in a bank account of the venue owner 130a. In some embodiments, after the show, all funds may be distributed as per the venue fixed price agreement on show costs. For example, show costs may be paid to the venue and the remaining balance net of show costs, digital marketing campaign if any, and any other approved costs may be paid to the performer 128a.

At action 249, the venue owner may rate the performer. For example, the venue owner 130a may rate the performer 128a, which may result in or contribute to ratings displayed to other venue owners in the touring app (e.g., to create a reputation for the performer that can be used by other venue owners). In some embodiments, this rating may be based on the experience of the fans 132a-132n who attend the show, the professional attitude of crew, the efficiency of production/costs, and the integrity in the settlement.

At action 250, a fan may log on to the touring app. For example, the fan 132a may log on, at action 250, to the touring app 109a with a username and password or other form of logon credential(s) or authentication.

At action 251, the fan may view available shows from available tours. For example, using the screens of FIGS. 20, 21, 22, and 23, the fan 132a may view, at action 251, shows from available tours.

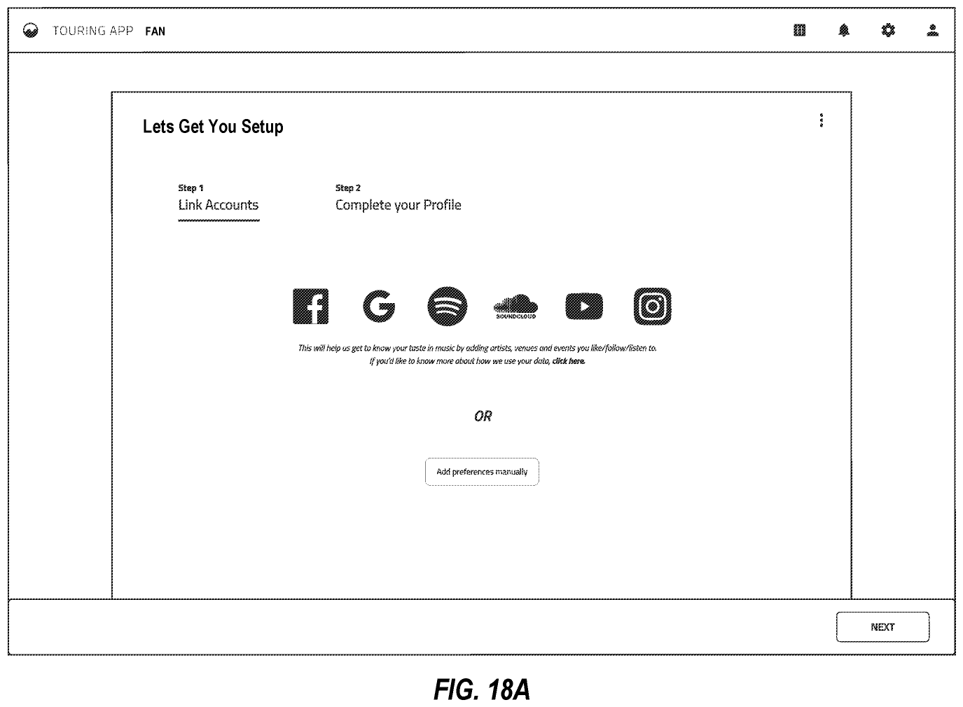

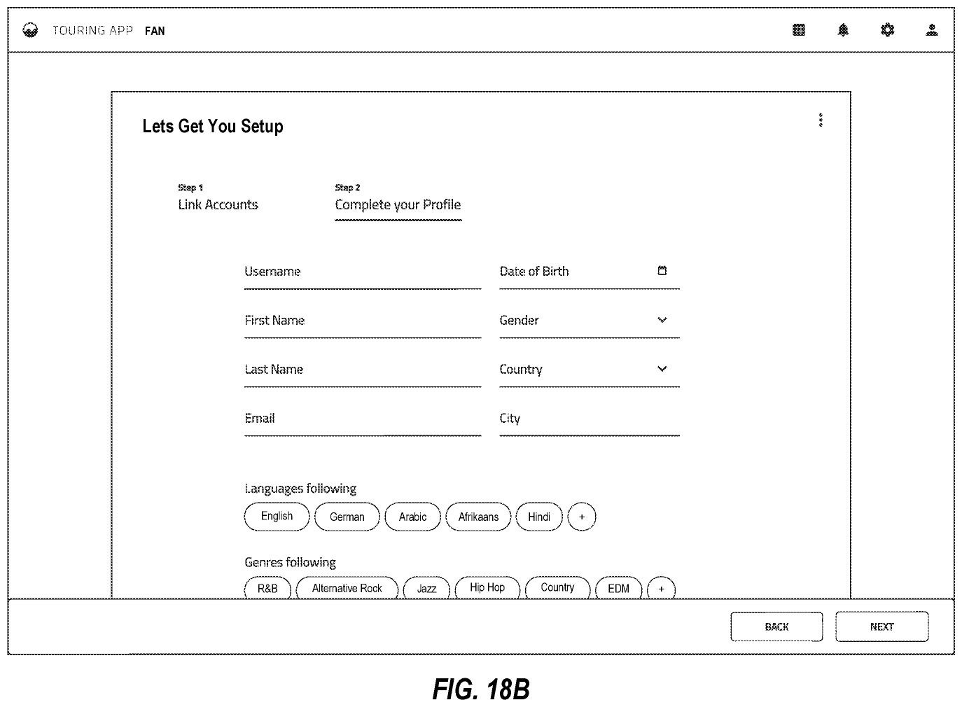

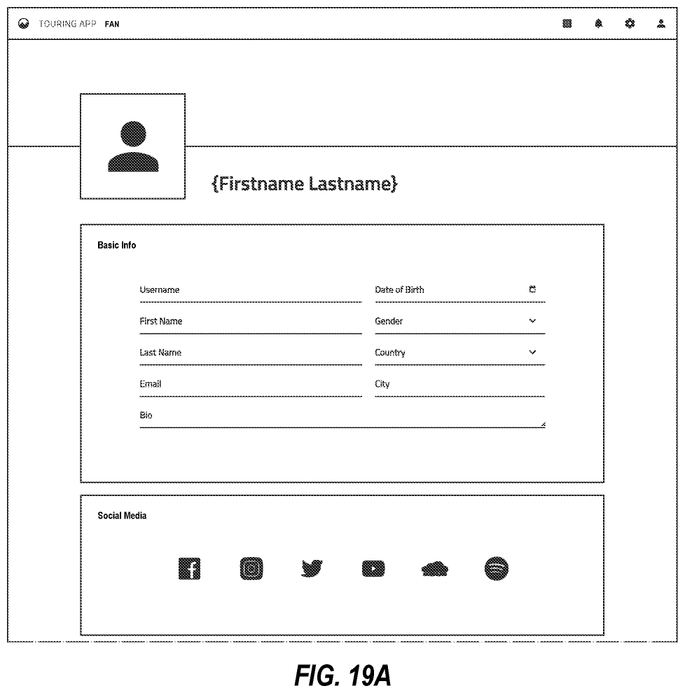

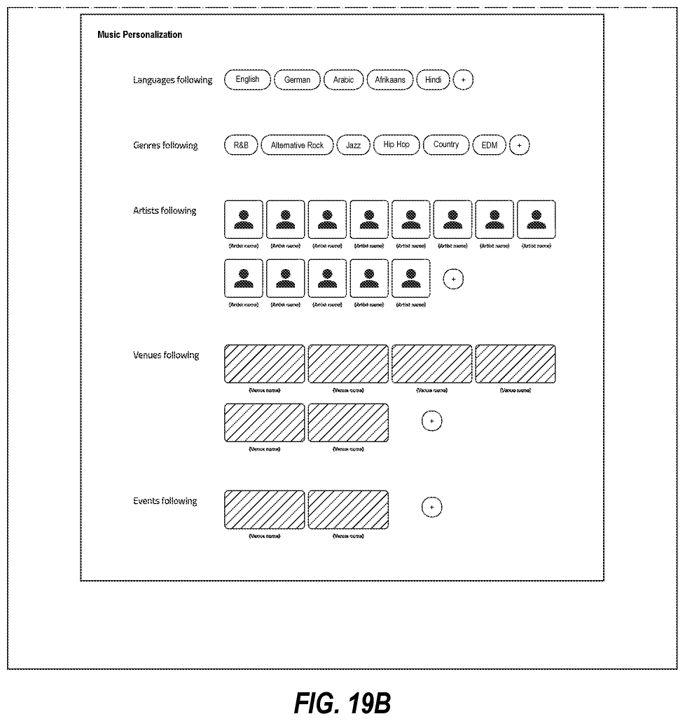

At action 252, the fan may input fan information including performer preferences and credit card information. For example, using the screens of FIGS. 18A-18B and 19A-19B, and the fan 132a may input fan information. As disclosed in FIGS. 18A and 19A, the fan information may include links between the account of the fan 132a in the touring app 109a with various social media accounts of the fan 132a (e.g., Facebook, Google, Spotify, Soundcloud, YouTube, Instagram, etc.). As disclosed in FIGS. 18B and 19A, the fan information may also include a fan username, a fan first name, a fan last name, a fan email, a fan date of birth, a fan gender, a fan country, a fan city. As disclosed in FIGS. 19A-19B, the fan information may also include languages the fan follows, genres the fan follows, performers the fan follows, venues the fan follows, and events the fan follows.

At action 253, the fan may place a ticket deposit on a show. For example, using the screens of FIGS. 20, 21, 22, and 23, the fan 132a may place, at action 253, a ticket deposit on a show. For example, as disclosed in FIG. 21, the fan 132a may use the touring app 109a to search for potential tickets to shows of tours by performer, by tour, or by venue. When the fan 132a selects a particular performer on the screen of FIG. 20, the fan 132a may arrive at the landing page disclosed in FIG. 21 for the performer 128a (e.g., for the Greywolves) where the fan 132a may learn more about the performer 128a and place a deposit on a ticket for an upcoming show by the performer 128a. Alternatively, when the fan 132a selects a particular tour on the screen of FIG. 20, the fan 132a may arrive at the landing page disclosed in FIG. 22 for the virtual tour of the performer 128a (e.g., for the Rockies Tour for the Greywolves) where the fan 132a may learn more about the virtual tour and place a deposit on a ticket for an upcoming show by the performer 128a that is tentatively (e.g., subject to receiving a sufficient number of deposits) included in the virtual tour. Alternatively, when the fan 132a selects a particular venue on the screen of FIG. 20, the fan 132a may arrive at the landing page disclosed in FIG. 23 for the venue (e.g., for the Prospera Place) where the fan 132a may learn more about the venue and place a deposit on a ticket for an upcoming show at the venue. In some embodiments, the fan 132a may acknowledge at the time of paying the ticket deposit that if the performer 128a confirm the show, the remainder of the full ticket price will automatically be charged (e.g., to the same debit or credit card used to pay the ticket deposit).

At action 254, the touring app may confirm or cancel the show. If the touring app confirms the show at action 254, the method 200 may continue to action 255. If the touring app cancels the show at action 255, the method 200 may continue to action 258. For example, the tour manager app 118 may, at action 254, confirm or cancel the show on which the fan 132a has placed a ticket deposit (e.g., the confirmation or cancellation may be based on the action 222).

At action 255, the touring app may charge a remainder of a full ticket price to deposit holders. For example, where the fan 132a was charged a deposit of $20 for a $100 ticket, the tour manager app 118 may charge, at action 255, the remainder of the full ticket price (e.g., the remaining $80) to the fan 132a (e.g., to the same credit/debit card to which the deposit was originally charged). The tour manager app 118 may also send paper tickets to the fan 132a and/or deliver digital tickets to the fan 132a (e.g., via the touring app 109a or via text or email or social media messaging).

At action 256, the fan may attend the show. For example, the fan 132a may attend the show at action 256. In some embodiments, the fan 132a may alternatively sell the ticket (e.g., if resale, or scalping, of tickets has been approved by the performer 128a), lose the ticket, or keep the ticket but not attend the show.

At action 257, the fan may rate the performer and the venue. For example, the fan 132a may rate, at action 257, the performer 128a and the venue where the show was held, which may result in or contribute to the 1-5 star ratings of the venues disclosed in FIG. 3 and/or FIG. 7A, and other similar ratings of the performer 128a. In some embodiments, this rating may be based on fan experience with the performer 128a and with the venue.

At action 258, the touring app may refund the ticket deposit for the cancelled show. For example, where the fan 132a was charged a deposit of $20 for a $100 ticket, the tour manager app 118 may refund, at action 258, the deposit (e.g., the deposit of $80) to the fan 132a (e.g., to the same credit/debit card to which the deposit was originally charged).

In some embodiments, the method 200 may employ the machine learning classifier 120 to automatically and relatively accurately project a number of the fans 132a-132n who will purchase tickets (or a number of tickets that will be sold), and a performer revenue for the performer 128a, for each of the venues in a virtual lineup of venues for a potential tour of the performer 128a. This relatively accurate projection of ticket sales and performer revenue on a venue-by-venue basis may enable the performer 128a to select venues for the potential tour that are most likely to attract the most fans for the performer 128a and/or to generate the most revenue for the performer 128a. This relatively accurate projection may therefore allow the performer 128a to determine in advance the financial viability of which venues to book on which dates. Further, this relatively accurate projection may also allow the performer 128a to cut out some or all of the middlemen (e.g., booking agents, promoters, managers, etc.) to reduce the costs of a tour and increase the performer revenue and the venue revenue from the tour.

Although the actions of the method 200 are illustrated in FIGS. 2A-2G as discrete actions, various actions may be divided into additional actions, combined into fewer actions, reordered, expanded, or eliminated, depending on the desired implementation. For example, in some embodiments, the action related to the virtual lineup may be performed without performing the actions related to the RFB, and vice-versa.

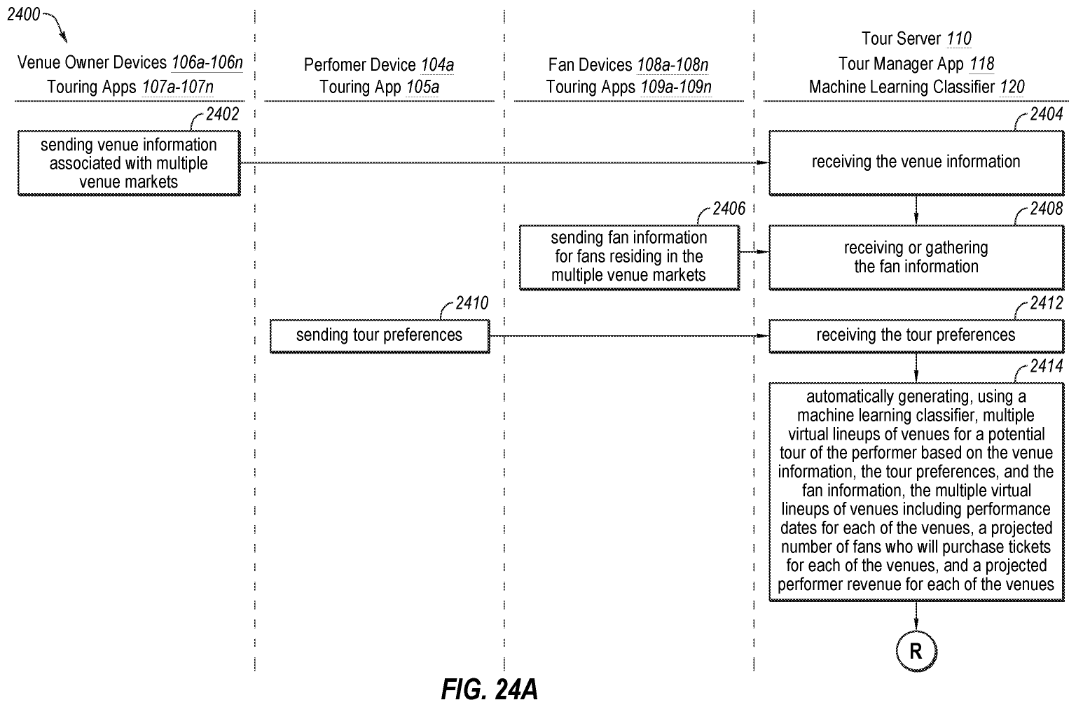

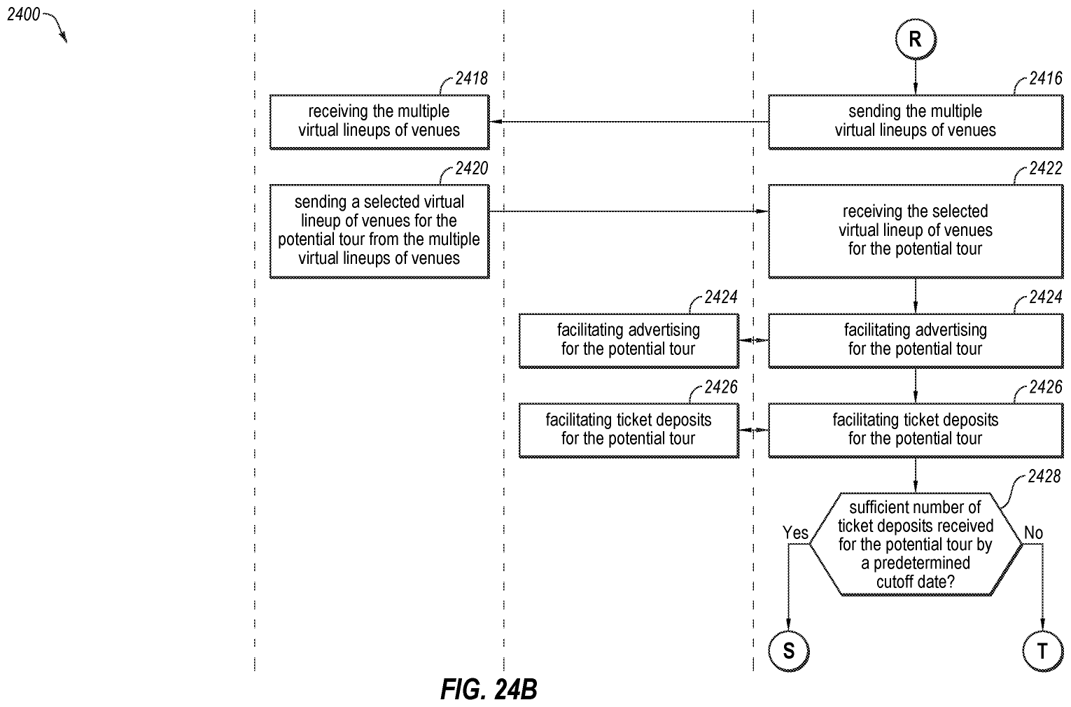

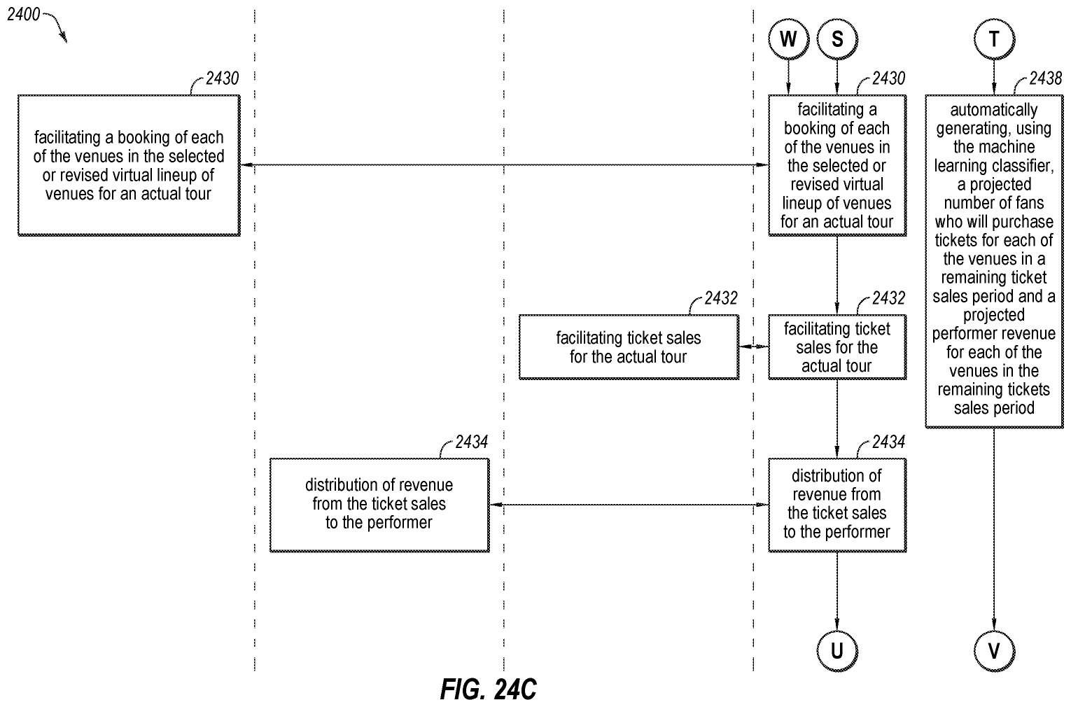

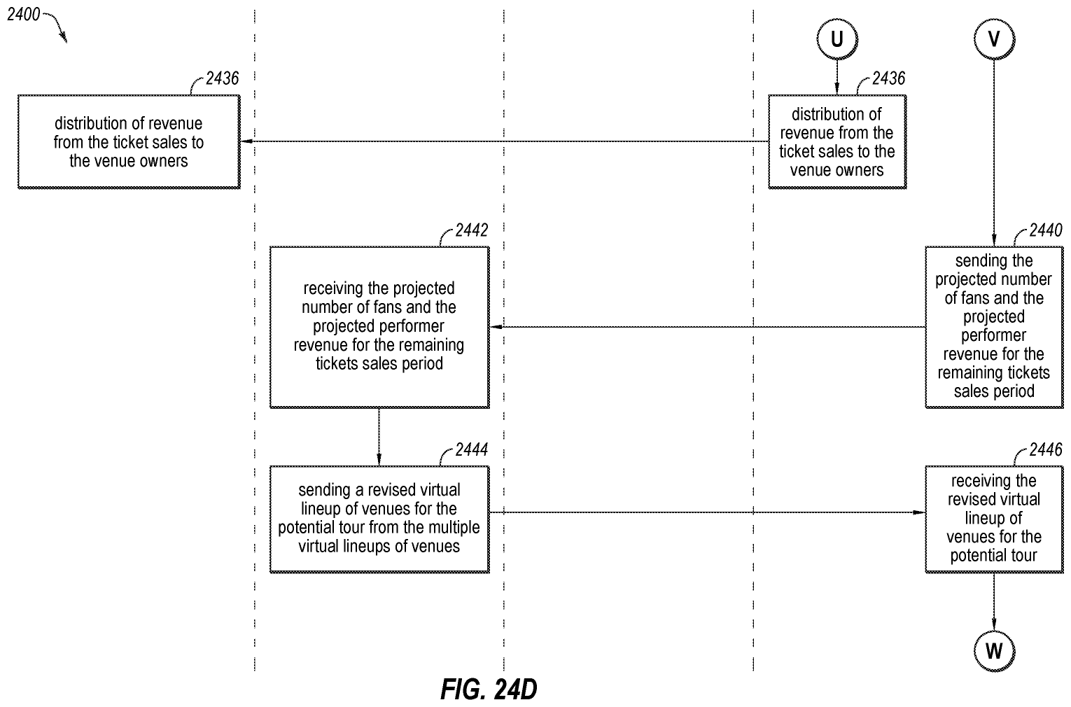

FIGS. 24A-24D are a flowchart of an example method for automatic generation of a virtual lineup of venues for a potential tour of a performer. The method 2400 may be performed, in some embodiments, by a device or system, such as by any of the touring apps 105a-105n, 107a-107n, and 109a-109n, and the tour manager app 118 of FIG. 1 (e.g., using the screens of FIGS. 3-23), or by some combination thereof, or by some other device or system. In these and other embodiments, the method 2400 may be performed by one or more processors based on one or more computer-readable instructions stored on one or more non-transitory computer-readable media. The method 2400 will now be described in connection with FIGS. 1-24D.

The method 2400 may include, at action 2402, sending and, at action 2404, receiving venue information associated with multiple venue markets. For example, the venue owners 130a-130n may use the touring apps 107a-107n running on the venue owner devices 106a-106n to send venue information associated with multiple venue markets to the tour manager app 118 running on the tour server 110, after which the tour manager app 118 may store the venue information in the venue information database 122. Further, the tour manager app 118 may integrate with venue databases through their published APIs to access and segment venue profile data, such as seating capacity, seating configurations, location, etc. Further, apart from venue profile details, the tour manager app 118 may gather information regarding the past performances at the venue, such as the artists, types of music, ticket sales, attendance, etc., to be used for modeling by the machine learning classifier 120. Also, the tour manager app 118 may integrate with, or develop configurable connectors for, the top venue management, booking, and ticketing software in order to access the booking and/or calendar information for venues and for booking tickets. In some embodiments, a venue market may include a geographic region around a venue from which the venue tends to draw fans to attend events. For example, if a venue is located in Los Angeles, the venue market of the venue may be the city of Los Angeles and the surrounding geographic area from which fans would tend to travel to attend an event at the venue. In some embodiments, the venue owners 130a-130n may use the screens of FIGS. 14-16 of the touring apps 107a-107n to input venue information.

The method 2400 may include, at action 2406, sending and, at action 2408, receiving or gathering fan information for fans residing in the multiple venue markets. For example, the fans 132a-132n may use the touring apps 109a-109n running on the fan devices 108a-108n to send fan information for the fans 132a-132n residing in the multiple venue markets to the tour manager app 118, after which the tour manager app 118 may store the fan information in the fan information database 126. Additionally or alternatively, the tour manager app 118 may gather the fan information from sources other than directly from the fans 132a-132n, such as from the social media platform 112 and/or the media streaming platform 114. For example, this gathering of fan data may include gathering fan data by the tour manager app 118 integrating with the media streaming platform 114 (e.g., Spotify, Deezer, YouTube Music, Twitch Music etc.) and the social media platform 112 (like Instagram, Facebook, TikTok, etc.) through their published APIs to access and segment fan data based on profiles of the fans 132a-132n, including the artists and genres they follow, fan location, fan age, events and festivals each fan has attended, etc. Further, the tour manager app 118 may access and segment data of the performer 128a by connecting to their channels in the social media platform 112 and/or the media streaming platform 114 based on profiles of the performer 128a, including the type of music they plan, their fan following, etc. Further, the tour manager app 118 may gather profile information of the fans 132a-132n such as the type of music and artists they follow or like during a fan onboarding process. Further, the same information may be gathered even where fan onboarding happens through a social media or media streaming sign-up process. In some embodiments, the fans 132a-132n may use the screens of FIGS. 18A-18B and 19A-19B of the touring apps 109a-109n to input fan information.

The method 2400 may include, at action 2410, sending and, at action 2412, receiving tour preferences. For example, the performer 128a may use the touring app 105a running on the performer device 104a to send tour preferences to the tour manager app 118, after which the tour manager app 118 may store the tour preferences in the tour preferences database 124. In some embodiments, the performer 128a may use the screens of FIGS. 3-5 of the touring app 105a to input fan information.

The method 2400 may include, at action 2414, automatically generating, using a machine learning classifier, multiple virtual lineups of venues for a potential tour of the performer based on the venue information, the tour preferences, and the fan information, the multiple virtual lineups of venues including performance dates for each of the venues, a projected number of fans who will purchase tickets for each of the venues (or a projected number of tickets that will be purchased for each of the venues), and a projected performer revenue for each of the venues. For example, the tour manager app 118 may automatically generate the multiple virtual lineups 121a-121n of venues for a potential tour of the performer 128a using the machine learning classifier 120. The machine learning classifier 120 may automatically generate the multiple virtual lineups 121a-121n of venues based on data from the venue information database 122, the tour preferences database 124, and the fan information database 126. The machine learning classifier 120 may have logic and algorithms built around the venue information, the fan information, and the tour preferences in order to accurately predicts fan demand for the performer 128a at each venue. In some embodiments, the generation of an optimal route for a potential tour by the machine learning classifier 120 may be accomplished by taking into account one or more of the following factors: (1) distance between different venues (e.g., which may involve integration with the Google Distance Matrix API), (2) modes of transportation between the venues, (3) demand in each market (e.g., prioritizing weekend dates for markets where the machine learning classifier 120 forecasts higher demand, etc.), (4) calendar availability of the venues, and (5) seating capacity of the venues. In some embodiments, the generation of a projected performer revenue for each of the venues by the machine learning classifier 120 may be accomplished by taking into account one or more of the following factors: (1) seating capacity of the venue, (2) fan demand at the venue as forecasted by the machine learning classifier 120, (3) the mean ticket price for the show at the venue, (4) the booking/processing fee, (5) taxes, (6) costs for the services from the venue as per the data provided during on-boarding (and which may be updated periodically), and (7) marketing services provided by the tour manager app 118 via the touring apps 109a-109n.

The method 2400 may include, at action 2416, sending and, at action 2418, receiving the multiple virtual lineups of venues. For example, the tour manager app 118 may send the multiple virtual lineups 121a-121n of venues for a potential tour of the performer 128a to the performer 128a via the touring app 105a. In some embodiments, the multiple virtual lineups 121a-121n of venues may be conveyed to the performer 128a using the screens of FIG. 5 of the touring app 105a.

The method 2400 may include, at action 2420, sending and, at action 2422, receiving a selected virtual lineup of venues for the potential tour from the multiple virtual lineups of venues. For example, the performer 128a may use the touring app 105a to send a selected one of the multiple virtual lineups 121a-121n of venues for a potential tour of the performer 128a to the tour manager app 118. In some embodiments, the selected virtual lineup of venues may be conveyed to the tour manager app 118 using the screens of FIGS. 5, 6, 8, and 9A-9C of the touring app 105a.

The method 2400 may include, at action 2424, facilitating advertising for the potential tour. For example, the tour manager app 118 may facilitate advertising for the potential tour, and the fans 132a-132n may use the touring apps 109a-109n to view the advertising for the potential tour. In some embodiments, the advertising for the potential tour may be facilitated by the tour manager app 118 using the screens of FIGS. 11A-11B of the touring app 105a and using the screens 20-23 of the touring apps 109a-109n.

The method 2400 may include, at action 2426, facilitating ticket deposits for the potential tour. For example, the tour manager app 118 may facilitate the taking of ticket deposits for the potential tour from the fans 132a-132n using the touring apps 109a-109n. In some embodiments, the taking of ticket deposits for the potential tour may be facilitated by the tour manager app 118 using the screens of FIGS. 20-23 of the touring apps 109a-109n.

The method 2400 may include, at action 2428, determining whether a sufficient number of ticket deposits have been received for the potential tour by a predetermined cutoff date. If so (yes at action 2428), method may proceed to action 2430. If not (no at action 2428), the method may proceed to action 2438. For example, the tour manager app 118 may determine whether a sufficient number of ticket deposits have been received from the fans 132a-132n for the potential tour by a predetermined cutoff date. In some embodiments, the determining of whether there are a sufficient number of ticket deposits may be accomplished by the tour manager app 118 using the screens of FIGS. 12A-12B and 13 of the touring apps 105a and 107a-107n, and using the virtual lineup progress status bar on the screen of FIG. 22 of the touring apps 109a-109n.

The method 2400 may include, at action 2430, facilitating a booking of each of the venues in a selected or revised virtual lineup of venues for an actual tour. For example, the tour manager app 118 may facilitate a booking of each of the venues in the selected virtual lineup of venues, or in a revised virtual lineup of venues, for an actual tour with the venue owners 130a-130n using the touring apps 107a-107n.

The method 2400 may include, at action 2432, facilitating ticket sales for the actual tour. For example, the tour manager app 118 running on the tour server 110 may facilitate ticket sales for the actual tour by the fans 132a-132n using the touring apps 109a-109n. In some embodiments, the selling of tickets for the potential tour (e.g., by getting payment for the remainder of ticket prices, or by selling tickets outright) may be facilitated by the tour manager app 118 using the screens of FIGS. 20-23 of the touring apps 109a-109n.

The method 2400 may include, at action 2434, distribution of revenue from the ticket sales to the performer. For example, the tour manager app 118 may distribute revenue from the ticket sales to the performer 128a using the touring app 105a.

The method 2400 may include, at action 2436, distribution of revenue from the ticket sales to the venue owners. For example, the tour manager app 118 may distribute revenue from the ticket sales to the venue owners 130a-130n using the touring apps 107a-107n.

The method 2400 may include, at action 2438, automatically generating, using the machine learning classifier, a projected number of fans who will purchase tickets for each of the venues (or a projected number of tickets that will be purchased for each of the venues) in a remaining ticket sales period and a projected performer revenue for each of the venues in the remaining tickets sales period. For example, the tour manager app 118 may automatically generate a projected number of the fans 132a-132n who will purchase tickets for each of the venues (or a projected number of tickets that will be purchased for each of the venues) in a remaining ticket sales period and a projected performer revenue for each of the venues in the remaining tickets sales period.

The method 2400 may include, at action 2440, sending and, at action 2442, receiving the projected number of fans and the projected performer revenue for the remaining tickets sales period. For example, the tour manager app 118 may send the projected number of fans and the projected performer revenue for the remaining tickets sales period to the performer 128a via the touring app 105a.

The method 2400 may include, at action 2444, sending and, at action 2446, receiving a revised virtual lineup of venues for the potential tour from the multiple virtual lineups of venues. For example, the performer 128a may use the touring app 105a to send a revised one of the multiple virtual lineups 121a-121n of venues for a potential tour of the performer 128a to the tour manager app 118.

In some embodiments, the method 2400 may employ machine learning classifier 120 to automatically and relatively accurately project a number of the fans 132a-132n who will purchase tickets (or a number of ticket that will be sold), and a performer revenue for the performer 128a, for each of the venues in a virtual lineup of venues for a potential tour of the performer 128a. This relatively accurate projection of ticket sales and performer revenue on a venue-by-venue basis may enable the performer 128a to select venues for the potential tour that are most likely to attract the most fans for the performer 128a and/or to generate the most revenue for the performer 128a. This relatively accurate projection may therefore allow the performer 128a to determine in advance the financial viability of which venues to book on which dates. Further, this relatively accurate projection may also allow the performer 128a to cut out some or all of the middlemen (e.g., booking agents, promoters, managers, etc.) to reduce the costs of a tour and increase the performer revenue and the venue revenue from the tour.

Although the actions of the method 2400 are illustrated in FIGS. 24A-24D as discrete actions, various actions may be divided into additional actions, combined into fewer actions, reordered, expanded, or eliminated, depending on the desired implementation. For example, in some embodiments, the action performed on or by the tour server 110 may be formed without performing the other actions of the method 2400. In one such example, the actions 2404, 2408, 2412, 2414, 2416, 2422, 2426, 2428, 2430, 2432, and 2434 may be performed without performing the other actions of the method 2400.

FIG. 25 illustrates an example computer system 2500 that may be employed in thwarting potentially malicious online activity. In some embodiments, the computer system 2500 may be part of any of the systems or devices described in this disclosure. For example, the computer system 2500 may be part of any of the performer devices 104a-104n, the venue owner devices 106a-106n, the fan devices 108a-108n, the tour server 110, the social media platform 112, and the media streaming platform 114 of FIG. 1.

The computer system 2500 may include a processor 2502, a memory 2504, a file system 2506, a communication unit 2508, an operating system 2510, a user interface 2512, and an application 2514, which all may be communicatively coupled. In some embodiments, the computer system may be, for example, a desktop computer, a client computer, a server computer, a mobile phone, a laptop computer, a smartphone, a smartwatch, a tablet computer, a portable music player, or any other computer system.

Generally, the processor 2502 may include any suitable special-purpose or general-purpose computer, computing entity, or processing device including various computer hardware or software applications and may be configured to execute instructions stored on any applicable computer-readable storage media. For example, the processor 2502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data, or any combination thereof. In some embodiments, the processor 2502 may interpret and/or execute program instructions and/or process data stored in the memory 2504 and/or the file system 2506. In some embodiments, the processor 2502 may fetch program instructions from the file system 2506 and load the program instructions into the memory 2504. After the program instructions are loaded into the memory 2504, the processor 2502 may execute the program instructions. In some embodiments, the instructions may include the processor 2502 performing one or more actions of the method 200 of FIGS. 2A-2G and/or the method 2400 of FIGS. 24A-24D.

The memory 2504 and the file system 2506 may include computer-readable storage media for carrying or having stored thereon computer-executable instructions or data structures. Such computer-readable storage media may be any available non-transitory media that may be accessed by a general-purpose or special-purpose computer, such as the processor 2502. By way of example, and not limitation, such computer-readable storage media may include non-transitory computer-readable storage media including Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage media which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 2502 to perform a certain operation or group of operations, such as one or more actions of the method 200 of FIGS. 2A-2G and/or the method 2400 of FIGS. 24A-24D. These computer-executable instructions may be included, for example, in the operating system 2510, or in one or more applications, such as the touring apps 105a-105n, 107a-107n, and 109a-109n and the tour manager app 118, or some combination thereof.

The communication unit 2508 may include any component, device, system, or combination thereof configured to transmit or receive information over a network, such as the network 102 of FIG. 1. In some embodiments, the communication unit 2508 may communicate with other devices at other locations, the same location, or even other components within the same system. For example, the communication unit 2508 may include a modem, a network card (wireless or wired), an infrared communication device, a wireless communication device (such as an antenna), and/or chipset (such as a Bluetooth device, an 802.6 device (e.g., Metropolitan Area Network (MAN)), a Wi-Fi device, a WiMax device, a cellular communication device, etc.), and/or the like. The communication unit 2508 may permit data to be exchanged with a network and/or any other devices or systems, such as those described in the present disclosure.

The operating system 2510 may be configured to manage hardware and software resources of the computer system 2500 and configured to provide common services for the computer system 2500.

The user interface 2512 may include any device configured to allow a user to interface with the computer system 2500. For example, the user interface 2512 may include a display, such as an LCD, LED, or other display, that is configured to present video, text, application user interfaces, and other data as directed by the processor 2502. The user interface 2512 may further include a mouse, a track pad, a keyboard, a touchscreen, volume controls, other buttons, a speaker, a microphone, a camera, any peripheral device, or other input or output device. The user interface 2512 may receive input from a user and provide the input to the processor 2502. Similarly, the user interface 2512 may present output to a user.

The application 2514 may be one or more computer-readable instructions stored on one or more non-transitory computer-readable media, such as the memory 2504 or the file system 2506, that, when executed by the processor 2502, is configured to perform one or more actions of the method 200 of FIGS. 2A-2G and/or the method 2400 of FIGS. 24A-24D. In some embodiments, the application 2514 may be part of the operating system 2510 or may be part of an application of the computer system 2500, or may be some combination thereof. In some embodiments, the application 2514 may function as the touring apps 105a-105n, 107a-107n, and 109a-109n and the tour manager app 118 of FIG. 1, or some combination thereof.

Modifications, additions, or omissions may be made to the computer system 2500 without departing from the scope of the present disclosure. For example, although each is illustrated as a single component in FIG. 25, any of the components 2502-2514 of the computer system 2500 may include multiple similar components that function collectively and are communicatively coupled. Further, although illustrated as a single computer system, it is understood that the computer system 2500 may include multiple physical or virtual computer systems that are networked together, such as in a cloud computing environment, a multitenancy environment, or a virtualization environment.

As indicated above, the embodiments described herein may include the use of a special purpose or general-purpose computer (e.g., the processor 2502 of FIG. 25) including various computer hardware or software applications, as discussed in greater detail below. Further, as indicated above, embodiments described herein may be implemented using computer-readable media (e.g., the memory 2504 or file system 2506 of FIG. 25) for carrying or having computer-executable instructions or data structures stored thereon.

In some embodiments, the different components and applications described herein may be implemented as objects or processes that execute on a computing system (e.g., as separate threads). While some of the methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A computer-implemented method performed by a server, the method comprising:
designating, by a server, a designated geographic region;
identifying a set of user accounts associated with mobile electronic devices located within the designated geographic region;
obtaining, by the server, information from a plurality of third party servers related to interactions of the user accounts with the plurality of third party servers;
receiving, at the server and from an advanced user account, a request for an automatically generated list of distinct geographic regions;
using a machine learning process, selecting a plurality of geographic regions as the list of distinct geographic regions, the designated geographic region included in the list of distinct geographic regions based on the machine learning process acting on the information from the third party servers and a quantity of the user accounts; and
transmitting the generated list of distinct geographic regions to an electronic device associated with the advanced user account.

2. The computer-generated method of claim 1, wherein selecting a plurality of geographic regions includes the machine learning process acting on a physical location of the electronic device associated with the advanced user account.

3. The computer-implemented method of claim 1, further comprising:
automatically generating, using the machine learning process, audiovisual content related to the advanced user account; and
transmitting the audiovisual content to the plurality of third-party servers.

4. The computer-implemented method of claim 1, further comprising:
receiving a communication from an entity in the designated geographic region; and
in response to receiving the communication, automatically selecting a secondary designated geographic region as an alternative to the designated geographic region.

5. The computer-implemented method of claim 1, further comprising:
detecting the distance between each of the distinct geographic regions;
automatically plotting, by the machine learning process, a route between each of the geographic locations; and
transmitting a graphical representation of the route to the electronic device associated with the advanced user account.

6. The method of claim 5 wherein automatically plotting, by the machine learning process, a route between each of the distinct geographic locations includes correlating a quantity of the user accounts with each of the distinct geographic locations.

7. The computer-implemented method of claim 1, further comprising:
automatically generating, using the machine learning process, a publication of the generated list of distinct geographic regions;
transmitting the publication to the third-party servers; and
modifying the list of distinct geographic regions based on subsequent interactions from the set of users being below a threshold.

8. The method of claim 3, further comprising:
modifying the list of distinct geographic regions based on subsequent interactions from the set of users with the audiovisual content related to the advanced user account being below a threshold.

9. The method of claim 7, further comprising:
generating, using the machine learning process, a second publication of the modified list of distinct geographic regions;
transmitting the second publication to the third-party servers; and
modifying the list of distinct geographic regions based on subsequent interactions from the set of users being below a threshold.

10. One or more non-transitory computer-readable media comprising instructions which, when executed by a processor, are configured to cause the processor to perform one or more operations, the operations comprising:
designate, by a server, a designated geographic region;
identify a set of user accounts associated with mobile electronic devices located within the designated geographic region;
obtain, by the server, information from a plurality of third party servers related to interactions of the user accounts with the plurality of third party servers;
receive, at the server and from an advanced user account, a request for an automatically generated list of distinct geographic regions;
using a machine learning process, select a plurality of geographic regions as the list of distinct geographic regions, the designated geographic region included in the list of distinct geographic regions based on the machine learning process acting on the information from the third party servers and a quantity of the user accounts; and
transmit the generated list of distinct geographic regions to an electronic device associated with the advanced user account.

11. The non-transitory computer-readable memory medium of claim 10, wherein selecting a plurality of geographic regions includes the machine learning process acting on a physical location of the electronic device associated with the advanced user account.

12. The non-transitory computer-readable memory medium of claim 10, comprising further instructions which, when executed by a processor, are configured to:
automatically generate, using the machine learning process, audiovisual content related to the advanced user account; and
transmit the audiovisual content to the plurality of third-party servers.

13. The non-transitory computer-readable memory medium of claim 10, comprising further instructions which, when executed by a processor, are configured to:
receive a communication from an entity in the designated geographic region; and
in response to receiving the communication, automatically select a secondary designated geographic region as an alternative to the designated geographic region.

14. The non-transitory computer-readable memory medium of claim 10, comprising further instructions which, when executed by a processor, are configured to:
detect the distance between each of the distinct geographic regions;
automatically plot, by the machine learning process, a route between each of the geographic locations; and
transmit a graphical representation of the route to the electronic device associated with the advanced user account.

15. The non-transitory computer-readable memory medium of claim 14 wherein automatically plotting, by the machine learning process, a route between each of the distinct geographic locations includes correlating a quantity of the user accounts with each of the distinct geographic locations.

16. The non-transitory computer-readable memory medium of claim 10, comprising further instructions which, when executed by a processor, are configured to:
automatically generate, using the machine learning process, a publication of the generated list of distinct geographic regions;
transmit the publication to the third-party servers; and
modify the list of distinct geographic regions based on subsequent interactions from the set of users being below a threshold.

17. The non-transitory computer-readable memory medium of claim 12, comprising further instructions which, when executed by a processor, are configured to:
modify the list of distinct geographic regions based on subsequent interactions from the set of users with the audiovisual content related to the advanced user account being below a threshold.

18. The non-transitory computer-readable memory medium of claim 16, comprising further instructions which, when executed by a processor, are configured to:
generate, using the machine learning process, a second publication of the modified list of distinct geographic regions;
transmit the second publication to the third-party servers; and
modify the list of distinct geographic regions based on subsequent interactions from the set of users being below a threshold.

19. A system, comprising:
one or more processors; and
one or more non-transitory computer-readable media comprising instructions which, when executed by the one or more processors, are configured to cause the system to perform one or more operations, the operations comprising:
designate, by a server, a designated geographic region;
identify a set of user accounts associated with mobile electronic devices located within the designated geographic region;
obtain, by the server, information from a plurality of third party servers related to interactions of the user accounts with the plurality of third party servers;
receive, at the server and from an advanced user account, a request for an automatically generated list of distinct geographic regions;
using a machine learning process, select a plurality of geographic regions as the list of distinct geographic regions, the designated geographic region included in the list of distinct geographic regions based on the machine learning process acting on the information from the third party servers and a quantity of the user accounts; and
transmit the generated list of distinct geographic regions to an electronic device associated with the advanced user account.

20. The system of claim 19, wherein selecting a plurality of geographic regions includes the machine learning process acting on a physical location of the electronic device associated with the advanced user account.
